(19) United States
(12) Patent Application Publication
(10) Pub. No.: US 2016/0219543 A1
(43) Pub. Date: Jul. 28, 2016

(54) METHOD FOR SETTING TIMING OF CONTROL CHANNEL IN TDD-FDD JOINT OPERATION AND APPARATUS THEREFOR

(71) Applicant: KT CORPORATION, Gyeonggi-do (KR)

(72) Inventors: Minseok NOH, Seoul (KR); Woo-jin CHOI, Seoul (KR)

(73) Assignee: KT CORPORATION, Gyeonggi-do (KR)

(21) Appl. No.: 15/024,899

(22) PCT Filed: Sep. 17, 2014
(86) PCT No.: PCT/KR2014/008639

§ 371 Date: Mar. 25, 2016

(30) Foreign Application Priority Data
Sep. 27, 2013 (KR) 10-2013-0115725
May 21, 2014 (KR) 10-2014-0061203

(51) Int. Cl. H04W 56/00; H04W 72/12

(52) U.S. Cl. CPC H04W 56/003; H04W 72/1268; H04W 72/1284

(57) ABSTRACT

A method and an apparatus may be provided for setting timing of receiving a control channel for uplink transmission, by a terminal configured with cells operating in different duplex modes. The timing for PUSCH transmission is set on the basis of transmission/reception timings of scheduling information for uplink data transmission and received PDCCH/EPDCCH in TDD-FDD joint operation and CA. Further, a method and an apparatus may be provided for processing a control channel by a terminal configured with a PCell and an SCell operating in different duplex modes. The method includes self-carrier scheduling at each of the PCell and the SCell and transmitting a PUSCH to each of the PCell and the SCell on the basis of the control channel received according to timing of receiving the control channel for uplink transmission in duplex modes of each of the PCell and the SCell.

### TECHNICAL FIELD

The present disclosure relates to a method of establishing timing of receiving a control channel for uplink transmission of a terminal using cells configured to operate in different duplex modes and an apparatus therefor. More particularly, the present disclosure relates to timing of receiving a control channel for transmitting data to a base station from a terminal that uses one or more cells operating in different duplex modes.

### BACKGROUND ART

Due to the development of communications systems, various types of wireless terminals have been introduced to consumers, such as companies and individuals. Current mobile communications systems belonging to the 3GPP family, such as long-term evolution (LTE) and LTE-Advanced, are high-speed, high capacity communications systems that have grown out of voice-centric services. These systems can transmit and receive various types of data, such as video data or wireless data. Thus, it is necessary to develop technologies allowing high capacity data to be transmitted at rates similar to those of wired communications networks. As deployments such as a plurality of cells or a plurality of small cells are introduced, a technology and a method able to apply carrier aggregation (CA) in a variety of deployment scenarios are required. In the meantime, a terminal can communicate with a base station using a variety of cells. In this case, the plurality of cells configured for the terminal may be divided into a primary cell (PCell) and a secondary cell (SCell) depending on the functions thereof. For example, the PCell provides a security input, is not changed without a handover process, and can transmit a control channel for an uplink (UL). One or more SCells may be configured as a set of serving cells together with the PCell, depending on user equipment (UE) capability.

In a joint operation associated with the Pcell and the Scell having different duplex modes, overall efficiency of the entire network is influenced by how to set up i) reception timing for receiving a control channel for UL data transmission and ii) transmission timing for transmitting a physical uplink shared channel (PUSCH) based on the received control channel.

### DISCLOSURE

### Technical Problem

It is necessary to set up timing of receiving a control channel (e.g., control channel reception timing) and physical uplink shared channel (PUSCH) timing for transmitting uplink (UL) data when carriers operating in different duplex modes for transmitting large amounts of data are aggregated.

### Technical Solution

In order to overcome the foregoing problem, an embodiment of the present disclosure provides a method of processing a control channel by a terminal configured with a PCell and an SCell operating in different duplex modes. The method includes: performing self-carrier scheduling on the PCell and the SCell; and transmitting a PUSCH to each of the PCell and the SCell, based on a control channel received in control channel reception timing which is timing of receiving a control channel for UL transmission in the duplex mode of each of the PCell and the SCell.

The present disclosure also provides a method of processing a control channel by a terminal configured with a PCell operating in TDD duplex mode and an SCell operating in FDD duplex mode. The method includes: performing cross-carrier scheduling on the SCell from the PCell; and transmitting a PUSCH to the SCell based on a control channel received from the PCell in control channel reception timing which is timing of receiving a control channel for UL transmission in the duplex mode of the PCell.

The present disclosure also provides a method of processing a control channel by a terminal configured with a PCell operating in TDD duplex mode and an SCell operating in FDD duplex mode. The method includes: performing cross-carrier scheduling on the SCell from the PCell; and transmitting a PUSCH to the SCell based on a control channel received from the PCell in control channel reception timing which his timing of receiving a control channel for UL transmission in the duplex mode of the SCell.

The present disclosure also provides a method of processing a control channel by a terminal configured with a PCell operating in FDD duplex mode and an SCell operating in TDD duplex mode are configured. The method includes: performing cross-carrier scheduling on the SCell from the PCell; and transmitting a PUSCH to the SCell based on a control channel received from the PCell in control channel reception timing which is timing of receiving a control channel for UL transmission in the duplex mode of the SCell.

The present disclosure also provides a method of processing a control channel by a terminal configured with a PCell operating in FDD duplex mode and an SCell operating in TDD duplex mode. The method includes: performing cross-carrier scheduling on the SCell from the PCell; and transmitting a PUSCH to the SCell based on a control channel received from the PCell in control channel reception timing which is timing of receiving a control channel for UL transmission in the duplex mode of the PCell.

The present disclosure also provides a method of controlling, by a base station, PUSCH transmission of a terminal configured with a PCell and an SCell operating in different duplex modes are configured. The method includes: controlling each of the PCell and the SCell to be subjected to self-carrier scheduling; and receiving a PUSCH transmitted to each of the PCell and the SCell based on a control channel transmitted from each of the PCell and the SCell in control channel reception timing which is timing of receiving a control channel for UL transmission in the duplex mode of each of the PCell and the SCell.

The present disclosure also provides a method of controlling, by a base station, PUSCH transmission of a terminal configured with a PCell and an SCell operating in different duplex modes. The method includes: controlling each of the PCell and the SCell to be subjected to self-carrier scheduling; and receiving a PUSCH transmitted to each of the PCell and the SCell based on a control channel transmitted from each of the PCell and the SCell in control channel reception timing which is timing of receiving a control channel for UL transmission in the duplex mode of each of the PCell and the PCell.

The present disclosure also provides a method of controlling, by a base station, PUSCH transmission of a terminal configured with a PCell operating in TDD duplex mode and an SCell operating in FDD duplex mode. The method includes: controlling the PCell to perform cross-carrier scheduling on the SCell; and receiving a PUSCH transmitted to the SCell based on a control channel for UL transmission of the SCell transmitted to the PCell in control channel reception timing which is timing of receiving a control channel for UL transmission according to the duplex mode of the SCell.

The present disclosure also provides a method of controlling, by a base station, PUSCH transmission of a terminal configured with a PCell operating in FDD duplex mode and an SCell operating in TDD duplex mode. The method includes: controlling the PCell to perform cross-carrier scheduling on the SCell; and receiving a PUSCH transmitted to the SCell based on a control channel for UL transmission of the SCell transmitted to the SCell in control channel reception timing which is timing of receiving a control channel for UL transmission according to the duplex mode of the SCell.

The present disclosure also provides a method of controlling, by a base station, PUSCH transmission of a terminal configured with a PCell operating in FDD duplex mode and an SCell operating in TDD duplex mode. The method includes: controlling the PCell to perform cross-carrier scheduling on the SCell; and receiving a PUSCH transmitted to the SCell based on a control channel for UL transmission of the SCell transmitted to the SCell in control channel reception timing which is timing of receiving a control channel for UL transmission according to the duplex mode of the PCell.

The present disclosure also provides a terminal for processing a control channel when a PCell and an SCell operating in different duplex modes are configured. The terminal includes: a controller configured to control the PCell and the SCell to be subjected to self-carrier scheduling; and a transmitter configured to transmit a PUSCH to each of the PCell and the SCell based on a control channel received in control channel reception timing which is timing of receiving a control channel for UL transmission in the duplex mode of each of the PCell and the SCell.

The present disclosure also provides a terminal for processing a control channel when a PCell operating in TDD duplex mode and an SCell operating in FDD duplex mode are configured. The terminal includes: a controller configured to control the SCell to be cross-carrier scheduled from the PCell; and a transmitter configured to transmit a PUSCH to the SCell based on a control channel received from the PCell in control channel reception timing which is timing of receiving a control channel for UL transmission according to the duplex mode of the PCell.

The present disclosure also provides a terminal for processing a control channel when a PCell operating in TDD duplex mode and an SCell operating in FDD duplex mode are configured. The terminal includes: a controller configured to control the SCell to be cross-carrier scheduled from the PCell; and a transmitter configured to transmit a PUSCH to the SCell based on a control channel received from the PCell in control channel reception timing which is timing of receiving a control channel for UL transmission according to the duplex mode of the SCell.

The present disclosure also provides a terminal for processing a control channel, in which a PCell operating in FDD duplex mode and an SCell operating in TDD duplex mode are configured. The terminal includes: a controller configured to control the SCell to be cross-carrier scheduled from the PCell; and a transmitter configured to transmit a PUSCH to the SCell based on a control channel received from the PCell in control channel reception timing which is timing of receiving a control channel for UL transmission according to the duplex mode of the SCell.

The present disclosure also provides a terminal for processing a control channel, in which a PCell operating in FDD duplex mode and an SCell operating in TDD duplex mode are configured. The terminal includes: a controller configured to control the SCell to be cross-carrier scheduled from the PCell; and a transmitter configured to transmit a PUSCH to the SCell based on a control channel received from the PCell in control channel reception timing which is timing of receiving a control channel for UL transmission according to the duplex mode of the PCell.

The present disclosure also provides a base station for controlling PUSCH transmission of a terminal, in which a PCell and an SCell operating in different duplex modes are configured. The base station includes: a controller configured to control the PCell and the SCell to be self-carrier scheduled; and a receiver configured to receive a PUSCH transmitted to each of the PCell and the SCell based on a control channel transmitted from each of the PCell and the SCell in control channel reception timing which is timing of receiving a control channel for UL transmission in the duplex mode of each of the PCell and the SCell.

The present disclosure also provides a base station for controlling PUSCH transmission of a terminal, in which a PCell operating in TDD duplex mode and an SCell operating in FDD duplex mode are configured. The base station includes: a controller configured to control the PCell to perform cross-carrier scheduling on the SCell; and a receiver configured to receive a PUSCH transmitted to the SCell based on a control channel regarding UL transmission of the SCell transmitted to the PCell in control channel reception timing which is timing of receiving a control channel for UL transmission according to the duplex mode of the PCell.

The present disclosure also provides a base station for controlling PUSCH transmission of a terminal, in which a PCell operating in TDD duplex mode and an SCell operating in FDD duplex mode are configured. The base station includes: a controller configured to control the PCell to perform cross-carrier scheduling on the SCell; and a receiver configured to receive a PUSCH transmitted to the SCell based on a control channel regarding UL transmission of the SCell transmitted to the PCell in control channel reception timing which is timing of receiving a control channel for UL transmission according to the duplex mode of the SCell.

The present disclosure also provides a base station for controlling PUSCH transmission of a terminal, in which a PCell operating in FDD duplex mode and an SCell operating in TDD duplex mode are configured. The base station includes: a controller configured to control the PCell to perform cross-carrier scheduling on the SCell; and a receiver configured to receive a PUSCH transmitted to the SCell based on a control channel regarding UL transmission of the SCell transmitted to the PCell in control channel reception timing which is timing of receiving a control channel for UL transmission according to the duplex mode of the SCell.

The present disclosure also provides a base station for controlling PUSCH transmission of a terminal, in which a PCell operating in FDD duplex mode and an SCell operating in TDD duplex mode are configured. The base station includes: a controller configured to control the PCell to perform cross-carrier scheduling on the SCell; and a receiver configured to receive a PUSCH transmitted to the SCell based on a control channel for UL transmission of the SCell transmitted to the PCell in control channel reception timing which is timing of receiving a control channel for UL transmission according to the duplex mode of the PCell.

### Advantageous Effects

According to the present disclosure as set forth above, it is possible to overcome the ambiguity of processes in which a terminal and a base station operating in different duplex modes and subjected to carrier aggregation operate according to the establishment of a PCell and an SCell.

In addition, according to the present disclosure, since reception timing for a control channel and transmission timing for a PUSCH are established, accuracy in the operations of transmitting and receiving UL and DL data can be improved, thereby improving the reliability of data transmission/reception due to carrier aggregation (CA).

### DESCRIPTION OF DRAWINGS

FIG. 1 is a diagram illustrating a small cell deployment according to an embodiment.

FIG. 2 is a diagram illustrating small cell deployment scenarios.

FIG. 3 to FIG. 6 are views illustrating specific scenarios in a small cell deployment.

FIG. 7 is a diagram illustrating a variety of scenarios in carrier aggregation (CA).

FIG. 8 is a table illustrating UL-DL configurations in a TDD frame structure.

FIG. 9 is a table illustrating PDCCH/EPDCCH timing for TDD UL transmission in TDD UL-DL configurations.

FIG. 10 is a table illustrating PHICH timing for TDD UL HARQ-ACK transmission in TDD UL-DL configurations.

FIG. 11 to FIG. 17 illustrate exemplary cases in which a TDD cell and an FDD cell are subjected to CA, the TDD cell having TDD UL-DL configurations 0 to 6 for TDD-FDD joint operation and CA.

FIG. 18 is a diagram illustrating an exemplary operation in which a terminal is subjected to self-carrier scheduling according to another embodiment of the present disclosure.

FIG. 19 is a diagram illustrating an exemplary operation in which a terminal is cross-carrier scheduled according to a further embodiment of the present disclosure.

FIG. 20 is a diagram illustrating an exemplary operation in which a terminal is cross-carrier scheduled according to further another embodiment of the present disclosure.

FIG. 21 is a diagram illustrating an exemplary operation in which a terminal is cross-carrier scheduled according to another embodiment of the present disclosure.

FIG. 22 is a diagram illustrating an exemplary operation in which a terminal is cross-carrier scheduled according to further another embodiment of the present disclosure.

FIG. 23 is a diagram illustrating an exemplary operation of a base station in case a terminal is self-carrier scheduled according to another embodiment of the present disclosure.

FIG. 24 is a diagram illustrating an exemplary operation of a base station in case a terminal is cross-carrier scheduled according to further another embodiment of the present disclosure.

FIG. 25 is a diagram illustrating an exemplary operation of a base station in case a terminal is cross-carrier scheduled according to still another embodiment of the present disclosure.

FIG. 26 is a diagram illustrating an exemplary operation of a base station in case a terminal is cross-carrier scheduled according to another embodiment of the present disclosure.

FIG. 27 is a diagram illustrating another exemplary operation of a base station is cross-carrier scheduled a terminal according to another embodiment of the present disclosure.

FIG. 28 is a diagram illustrating the configuration of a terminal according to another embodiment of the present disclosure.

FIG. 29 is a diagram illustrating the configuration of a base station according to further another embodiment of the present disclosure.

### BEST MODE

Reference will now be made in detail to embodiments of the present disclosure, examples of which are illustrated in the accompanying drawings. Throughout this document, reference should be made to the drawings, in which the same reference numerals and signs will be used to designate the same or like components. In the following description of the present disclosure, detailed descriptions of known functions and components incorporated herein will be omitted in the case that the subject matter of the present disclosure may be rendered unclear thereby.

Herein, a wireless communications system may be widely distributed in order to provide various types of communications services, such as a voice conversation service, a data packet service, or the like. Here, a wireless communications system includes sets of user equipment (UE) and base stations (BSs) or evolved node-Bs (eNBs). As used in the specification, the term “user equipment” has a comprehensive meaning indicating a wireless communications terminal, and should be interpreted as not only indicating the user equipment in the wideband code division multiple access (WCDMA) scheme, the long-term evolution (LTE) scheme, the high speed packet access (HSPA) scheme, and the like, but also including all of a mobile station (MS), a user terminal (UT), a subscriber station (SS), a wireless device, and the like, in the global system for mobile communications (GSM) scheme.

A base station or a cell typically refers to a station that communicates with the user equipment. The base station may be referred to using another term, such as a node-B, an evolved node-B (eNB), a sector, a site, a base transceiver system (BTS), an access point, a relay node, a remote radio head (RRH), a radio unit (RU), a small cell, or the like.

Specifically, in the specification, the base station or cell should be interpreted as having a comprehensive meaning indicating a partial area or a function covered by a base station controller (BSC), a node-B in the WCDMA scheme, an eNB or a sector (site) in the LTE scheme, or the like. The base station or cell comprehensively includes a variety of coverage areas, such as a mega cell, a macro cell, a microcell, a picocell, a femtocell, and a variety of communications ranges of a relay node, an RRH, an RU, and a small cell.

Each of the variety of cells as enumerated above is controlled by a base station, and the base station may be interpreted in two senses. The base station i) may be an apparatus that provides a mega cell, a macro cell, a microcell, a picocell, a femtocell, or a small cell in relationship to a wireless area, or ii) may indicate the wireless area. In i), entire apparatuses providing wireless areas are controlled by the same entity or entire apparatuses interacting with one another to form a wireless area in a coordinated manner are referred to as base stations. An eNB, an RRH, an antenna, an RU, a low power node (LPN), a point, a transceiver point, a transmission point, a reception point, and the like form embodiments of the base station, depending on the configuration of the wireless area. In ii), in terms of a user or in terms of an adjacent base station, the wireless area in which a signal is received or transmitted can be referred to as a base station.

Thus, the mega cell, the macro cell, the microcell, the picocell, the femtocell, the small cell, the RRH, the antenna, the RU, the LPN, the point, the eNB, the transceiver point, the transmission point, and the reception point are collectively referred to as the base stations.

In the specification, the user equipment and the base station are comprehensively referred to as two types of transmission/reception entities for realizing technologies or technical concepts described herein and are not limited by terms or words that are explicitly defined. The user equipment and the base station are comprehensively used as two transmission/reception (uplink and downlink) entities for realizing technologies or technical concepts described herein and are not limited by terms or words that are explicitly defined. Here, the term “uplink (UL)” relates to data transmission/reception in which data is transmitted from the user equipment to the base station, whereas the term “downlink (DL)” relates to data transmission/reception in which data is transmitted from the base station to the user equipment.

There are no limitations in multiple access technologies applied to the wireless communications system. A variety of multiple access methods, such as code division multiple access (CDMA), time division multiple access (TDMA), frequency division multiple access (FDMA), orthogonal frequency division multiple access (OFDMA), OFDM-FDMA, OFDM-TDMA, and OFDM-CDMA, can be used. An exemplary embodiment of the present disclosure is applicable for the allocation of resources in asynchronous wireless communications evolving into long-term evolution (LTE) and LTE-Advanced through GSM, WCDMA, and high speed packet access (HSPA) and synchronous wireless communications evolving into CDMA, CDMA-2000, and ultra mobile broadband (UMB). The present disclosure should not be interpreted as being limited or restricted to a specific field of wireless communications and should be interpreted as including all technical fields to which the concept of the present disclosure is applicable.

Uplink (UL) transmission and downlink (DL) transmission may employ time division duplex (TDD) in which transmission is performed at different fractions of time or frequency division duplex (FDD) in which transmission is performed at different fractions of time.

In addition, a system such as LTE or LTE-Advanced forms a standard by forming a UL and a DL based on a single carrier wave or a pair of carrier waves. The UL and the DL transmit control information through a control channel, such as a physical downlink control channel (PDCCH), a physical control format indicator channel (PCFICH), a physical hybrid-ARQ indicator channel (PITCH), a physical uplink control channel (PUCCH), and an enhanced physical downlink control channel (EPDCCH), and are constituted of a data channel, such as a physical downlink shared channel (PDSCH) or a physical uplink shared channel (PUSCH), to transmit data.

Alternatively, it is possible to transmit control information using an enhanced or extended PDCCH (EPDCCH).

In the specification, the cell may refer to a transmission or transmission/reception point, the coverage of a signal transmitted from the transmission or transmission/reception point, or a component carrier having the coverage of the signal transmitted from the transmission or transmission/reception point.

The wireless communication system to which embodiments are applied may be a coordinated multi-point transmission/reception System (CoMP) system in which two or more transmission/reception points transmit a signal in a coordinated manner, a coordinated multi-antenna transmission system, or a coordinated multi-cell communications system. The CoMP system may include at least two multi-transmission/reception points and terminals.

The multi-transmission/reception points may be a base station or a macro cell (hereinafter referred to as an “eNB”) and at least one RRH connected to the eNB via a fiber optic cable or a optical fiber and controlled by wires. The RRH has high transmission power, or has low transmission power within the area of the macro cell.

Hereinafter, the DL refers to communications from each multi-transmission/reception point to the terminal or a path for such communications. The UL refers to communications from the terminal to the multi-transmission/reception point or a path for such communications. In the DL, a transmitter may be a portion of the multi-transmission/reception point, and a receiver may be a portion of the terminal. In the UL, the transmitter may be a portion of the terminal, and the receiver may be a portion of the multi-transmission/reception point.

Hereinafter, when a signal is transmitted/received via a channel, such as the PUCCH, PUSCH, PDCCH, EPDCCH, or physical PDSCH, it may be described that “a PUCCH, PUSCH, PDCCH, EPDCCH, or PDSCH is transmitted/received.”

In addition, hereinafter, transmitting or receiving a PDCCH or transmitting or receiving a signal on the PDCCH may refer to transmitting or receiving an EPDCCH or transmitting or receiving a signal on the EPDCCH.

That is, the PDCCH or control channel described hereinafter indicates the PDCCH or the EPDCCH, or is used as including both the PDCCH and the EPDCCH.

For the sake of explanation, the EPDCCH may be applied as an embodiment of the present disclosure to the portion described as being the PDCCH, and the PDCCH may be applied as an embodiment of the present disclosure to the portion described as being the EPDCCH.

In the meantime, high layer signaling described hereinafter includes radio resource control (RRC) signaling that transmits RRC information including an RRC parameter.

The eNB performs DL transmission to terminals. The eNB may transmit a physical downlink shared channel (PDSCH), which is a main channel for unicast transmission, and a physical downlink control channel (PDCCH), on which DL control information, such as scheduling necessary for the reception of the PDSCH, and scheduling approval information for transmission on a UL data channel (e.g. a physical uplink shared channel (PUSCH)) are transmitted. Hereinafter, the transmission of a signal on each channel will be described as the transmission of the relevant channel.

A small cell using a low-power node is considered as a means for dealing with rapid increases in the amount of mobile traffic. The low-power node refers to a node that uses lower transmission (Tx) power than typical macro-nodes.

According to carrier aggregation (CA) technology before 3GPP Release 11, it was possible to construct a small cell using a low-power remote radio head (RRH), i.e. one of geographically dispersed antennas, within the coverage area of a macro cell.

However, for the application of the above-mentioned CA technology, the macro cell and the RRH cell are constructed in such a manner as to be scheduled under the control of a single base station. Here, it is necessary to construct an ideal backhaul between the node of the macro cell and the RRH.

The ideal backhaul refers to a backhaul exhibiting a very high throughput and a very short time delay, as in a dedicated point-to-point (PTP) connection using optical fibers or a line-of-sight (LOS) microwave link.

In contrast, a backhaul, such as a digital subscriber line (xDSL) or a non-LOS microwave link, exhibiting a relatively low throughput and a relatively long delay is referred to as a non-ideal backhaul.

A plurality of serving cells may be aggregated using the above-mentioned CA technology, based on a single base station, to provide a service to a terminal. That is, a plurality of serving cells may be provided for a radio resource control (RCC)-connected terminal. When the ideal backhaul is constructed between the node of the macro cell and the RRH, both the macro cell and the RRH cell may be provided as serving cells to provide a service to the terminal.

That is, when the CA technology based on a single base station is formed, the terminal may have a single RRC connection with the network.

In RRC connection establishment, reestablishment, and handover, a single serving cell provides non-access stratum (NAS) mobility information (e.g. tracking area identity (TAI)). In RRC connection reestablishment and handover, a single cell provides a security input. This cell is referred to as the primary cell (PCell). Depending on terminal capabilities, a secondary cell (SCell) may form the serving cell together with the PCell.

The present disclosure relates to a method and apparatus for operating a terminal and a method and apparatus for enabling a base station to use the same method, in which the terminal belonging to the relevant base station is enabled to support a joint operation between TDD and TDD, in case a small cell and at least one of a cell, a base station, an RRH, an antenna, and an RU in a multi-cell structure support different duplex modes, i.e. FDD and TDD. In addition, the present disclosure relates to a method and apparatus for establishing control channel reception and PUSCH transmission timing and hybrid automatic repeat request-acknowledgement (HARQ-ACK) timing regarding the CA and joint operation between the macro cell and the small cell and the UL transmission of the terminal in case respective duplex modes are used in a macro cell, a small cell, and at least one of a cell, a base station, an RRH, an antenna, and an regardless of the duplex modes.

Hereinafter, a small cell deployment scenario to which proposals of the present disclosure are applicable will be described.

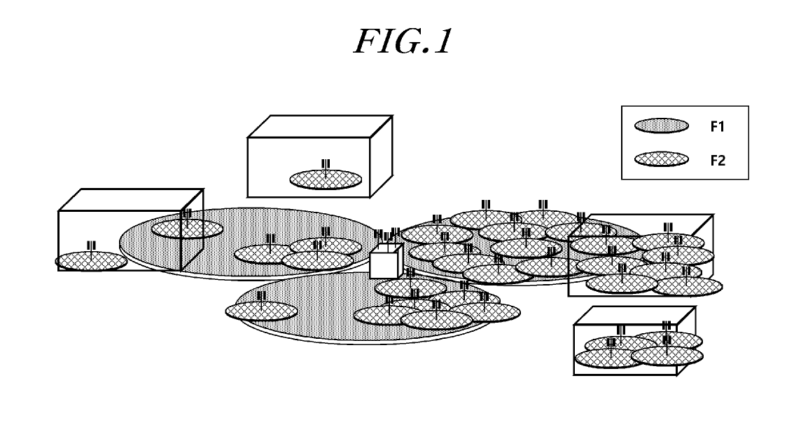

FIG. 1 is a diagram illustrating a small cell deployment according to an embodiment.

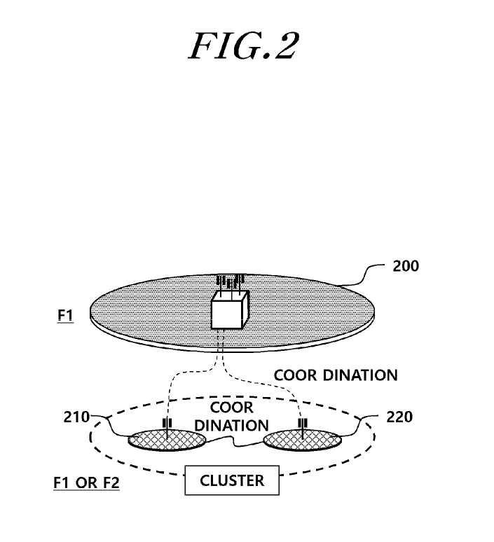

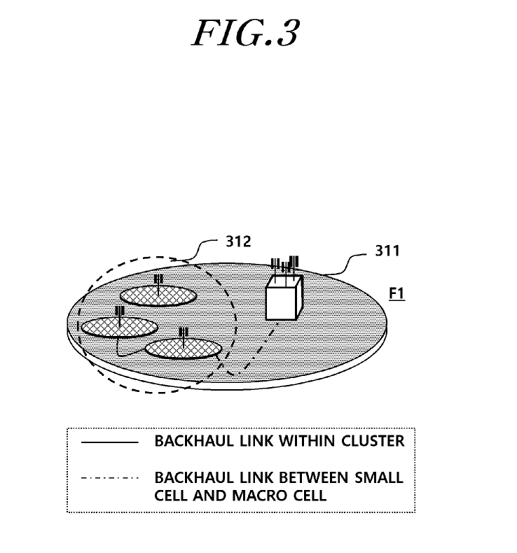

FIG. 1 illustrates a configuration where small cells and macro cells coexist. This configuration will be divided more specifically in FIG. 2 and FIG. 3 below, depending on whether or not a macro coverage area is present, whether or not a relevant small cell is intended to be situated outdoors or indoors, whether or not the deployment of the relevant small cell is sparse or dense, and whether or not the same frequency spectrum as that of the macro coverage area is used, in terms of spectrum. Detailed scenario configurations will be described with reference to FIG. 2 to FIG. 6.

FIG. 2 is a diagram illustrating small cell deployment scenarios. FIG. 2 represents a general representative configuration of scenarios illustrated in FIG. 3 to FIG. 6. FIG. 2 illustrates the small cell deployment scenario including scenarios #1, #2a, #2b, and #3. 200 indicates a macro cell, and 210 and 220 indicate small cells. In FIG. 2, an overlaid cell may be present or absent. Coordination may be performed between the macro cell and the small cells 210 and 220, and coordination may be performed between the small cells 210 and 220. Overlaid areas of 200, 210, and 220 may be bound as clusters.

FIG. 3 to FIG. 6 are views illustrating specific scenarios in the small cell deployment.

FIG. 3 illustrates a small cell deployment scenario #1 in the small cell deployment. The small cell deployment scenario #1 is a co-channel deployment scenario of small cells and a macro cell when an overhead macro is present, and is an outdoor small cell scenario. A reference numeral 310 indicates a case in which both a macro cell 311 and small cells are outdoor cells, and a reference numeral 312 indicates a small cell cluster. All users are distributed indoors and outdoors.

A solid line connecting the small cells in the small cell cluster 312 indicates a backhaul link within the cluster. A dot-dash line connecting a base station of the macro cell and a small cell among the small cells within the cluster indicates a backhaul link between the small cell and the macro cell.

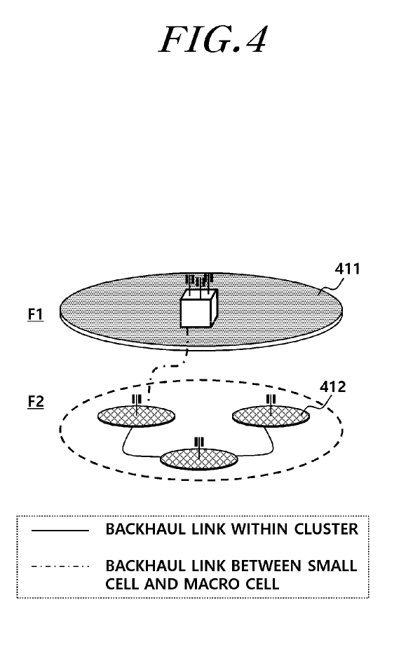

FIG. 4 illustrates small cell deployment scenario #2a. The small cell deployment scenario #2a is a deployment scenario in which small cells and a macro cell use different frequency spectra in the presence of an overlaid macro cell, and is an outdoor small cell scenario. All of the macro cell 411 and the small cells are situated outdoors, and a reference numeral 412 indicates a small cell cluster. All users are distributed indoors and outdoors.

Solid lines connecting the small cells within the small cell cluster 412 indicate backhaul links within the cluster. A dot-dash line connecting a base station of the macro cell and a small cell among the small cells within the cluster indicates a backhaul link between the small cell and the macro cell.

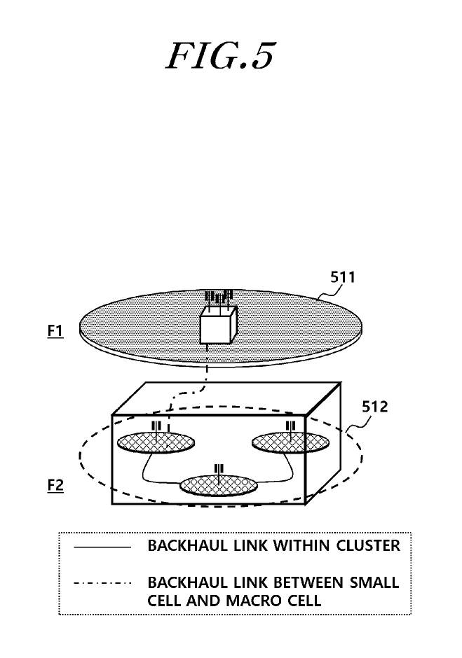

FIG. 5 illustrates small cell deployment scenario #2b. The small cell deployment scenario #2b is a deployment scenario in which small cells and a macro cell use different frequency spectra in the presence of an overlaid macro cell, and is an indoor small cell scenario. The macro cell 511 is situated outdoors, the entire small cells are situated indoors, and the reference numeral 512 indicates a small cell cluster. All users are distributed indoors and outdoors.

Solid lines connecting the small cells within the small cell cluster 512 indicate backhaul links within the cluster. A dot-dash line connecting a base station of the macro cell and a small cell among the small cells within the cluster indicates a backhaul link between the small cell and the macro cell.

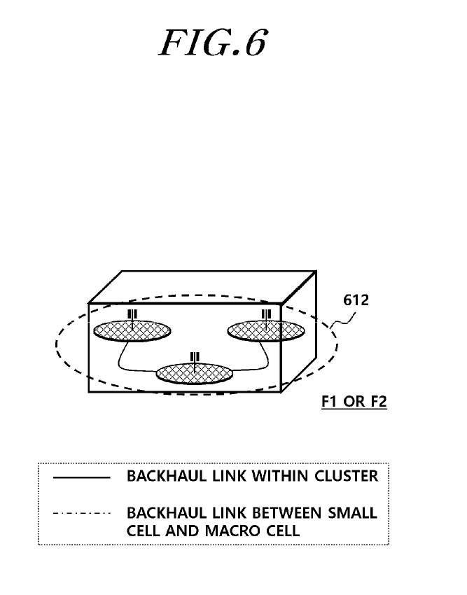

FIG. 6 illustrates small cell deployment scenario #3. The small cell deployment scenario #3 is an indoor small cell scenario in case there is no macro coverage area. A reference numeral 612 indicates a small cell cluster. All small cells are situated indoors, and all users are distributed indoors and outdoors.

Solid lines connecting the small cells within the small cell cluster 612 indicate backhaul links within the cluster. Dot-dash lines connecting a base station of a macro cell and the small cells within the cluster indicate backhaul links between the small cells and the macro cell.

Frequencies F1 and F2 used in FIG. 1 and in the variety of small cell scenarios of FIG. 2 to FIG. 6 as described above may be frequencies supporting the same duplex mode or may have different duplex modes. For example, the frequency F1 may be a frequency supporting FDD mode, and the frequency F2 may be a frequency supporting TDD mode, and vice versa.

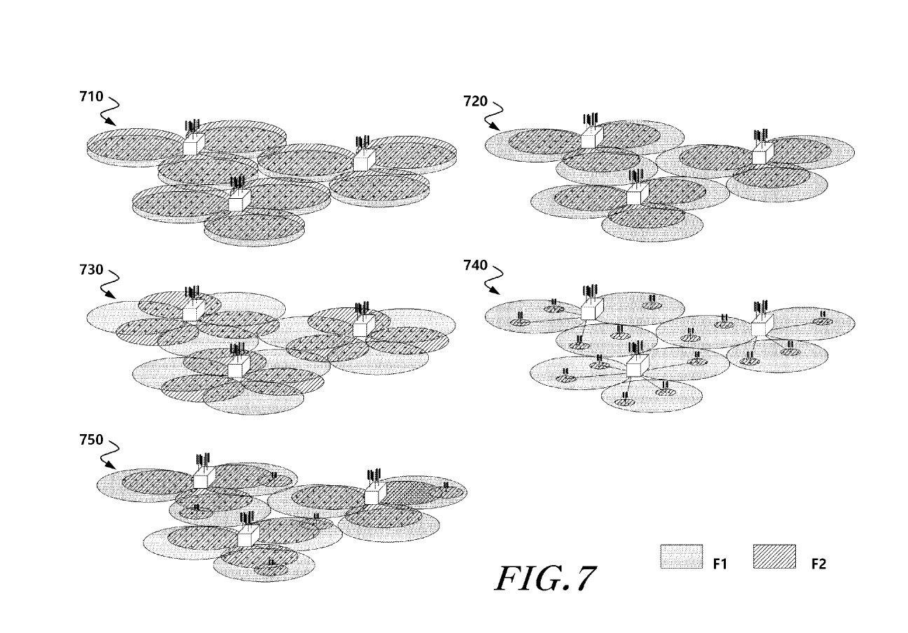

FIG. 7 is a diagram illustrating a variety of scenarios in carrier aggregation (CA).

In the CA illustrated in FIG. 7, the frequencies F1 and F2 may be considered to be frequencies supporting the same duplex mode or frequencies supporting different duplex modes.

In a scenario 710, F1 and F2 cells are overlaid while being co-located in substantially the same coverage areas. Two layers are scenarios that provide sufficient coverage areas and mobility, and cell aggregation between overlaid F1 and F2 cells is possible.

A reference numeral 720 indicates a scenario in which F1 and F2 cells are co-located and overlaid, in which each coverage area of the frequency F2 is smaller than the relevant coverage area of the frequency F1. F1 has sufficient coverage areas, and mobility support is performed based on the coverage areas of the frequency F1. The frequency F2 is a scenario used to improve throughput. In this scenario, cell aggregation between overlaid F1 and F2 cells is possible.

A reference numeral 730 indicates a scenario in which F1 and F2 cells are co-located but F2 antennas are directed to cell boundaries in order to improve cell edge throughputs. In this scenario, mobility support is performed based on the coverage areas of the frequency F1. Although the frequency F1 has sufficient coverage areas, the frequency F2 has temporary coverage holes. In the same eNB, the F1 and F2 cells can be aggregated in the overlaid coverage areas.

A reference numeral 740 indicates a scenario in which the frequency F1 has macro coverage areas and RRHs are used in the frequency F2 in order to improve throughputs in hot spots. Mobility support is performed based on the coverage areas of the frequency F1. The cells of the RRHs of the frequency F2 can be aggregated with F1 macro cells.

A reference numeral 750 indicates a scenario in which each of frequency selective repeaters is deployed in order to expand the coverage area of a single carrier, like the scenario 720. In this scenario, the F1 and F2 cells in the same eNB can be aggregated in the overlaid coverage areas.

In the specification, if a terminal has dual connectivity, a base station that forms an RRC connection with the terminal and provides a cell (e.g. a PCell) based on which handover is performed or a base station that terminates an Si-mobility management entity (S1-MME) and serves as a mobility anchor for a core network is described as a master base station or a first base station.

The master base station or the first base station may be a base station that provides a macro cell, or in the case of a dual connectivity deployment between small cells, provides any one of the small cells.

In the meantime, a base station that provides additional wireless resources to the terminal, distinguished from the master base station in the dual connectivity deployment, is described as a secondary base station or a second base station.

Each of the first base station (e.g., master base station) and the second base station (e.g., secondary base station) can provide at least one cell to the terminal, and the first base station and the second base station can be connected to each other through an interface therebetween.

In addition, for a better understanding, a cell related to the first base station may be described as being a macro cell, and a cell related to the second base station may be described as being a small cell. Alternatively, in the above-described small cell cluster scenario, the cell related to the first base station may be described as being a small cell.

In the present disclosure, the macro cell may refer to a cell or each of at least two cells, or may be described as representing entire cells related to the first base station. In addition, the small cell may refer to a cell or each of at least two cells, or may be described as representing entire cells related to the second base station. Alternatively, the small cell may be a cell related to the first base station in a specific scenario, as of a small cell cluster as described above. In this case, a cell of the second base station may be described as being an additional small cell or a further small cell.

In the following description of embodiments, for the sake of explanation, the macro cell may be related to the master base station or the first base station, and the small cell may be related to the secondary base station or the second base station. However, the present disclosure is not limited thereto, and embodiments of the present disclosure may be applied to a case in which the secondary base station or the second base station is related to the macro cell and the master base station or the first base station is related to the small cell.

In addition, in the specification, FDD may refer to frame structure type 1, and TDD may refer to frame structure type 2.

In case carrier aggregation (CA) is supported, CA in each of the FDD and TDD duplex modes may be considered. When CA in the same mode as in FDD or TDD is considered, it may be established such that component carriers (CCs) are divided as below.

First, the primary cell (PCell) will be described.

When CA is formed, the terminal has a single RRC connection with a network. In the case of RRC connection establishment, reestablishment, and handover, a single serving cell provides NAS mobility information. In the case of RRC connection reestablishment and handover, a single serving cell provides a security input. This cell is referred to as the primary cell. In a DL, a carrier corresponding to the PCell is a downlink primary component carrier (DL PCC). In a UL, the carrier corresponding to the PCell is an uplink primary component carrier (UL PCC).

The PCell can only be changed by a handover procedure. The PCell is used for the transmission of a PUCCH. In addition, the PCell cannot be de-activated unlike an SCell. The reestablishment is triggered when the PCell experiences a radio link failure (RLF) but is not triggered when the SCell experiences the RLF. In addition, NAS information is obtained from the PCell.

In subsequence, the secondary cells (SCells) will be described.

The SCells may form a set of serving cells together with the PCell, in dependence on terminal capability. A carrier corresponding to an SCell in a DL is a DL secondary component carrier (DL SCC), and a carrier corresponding to an SCell in a UL is a UL secondary component carrier (UL SCC).

Three serving cells among the set of serving cells formed for a single terminal constantly include a single PCell and one or more SCells. The number of serving cells depends on the aggregation capability of the terminal.

Reestablishment (e.g., reconfiguration) and the addition and removal of SCells may be enabled through the RRC. The SCells may be reestablished, added, or removed through the RRC in order to be used together with a target PCell during intra-LTE handover. When a new SCell is added, dedicated RRC signaling is used in order to transmit the entire system information of the SCell as requested. In a connected mode, the terminal is not required to directly obtain broadcast system information from the SCells.

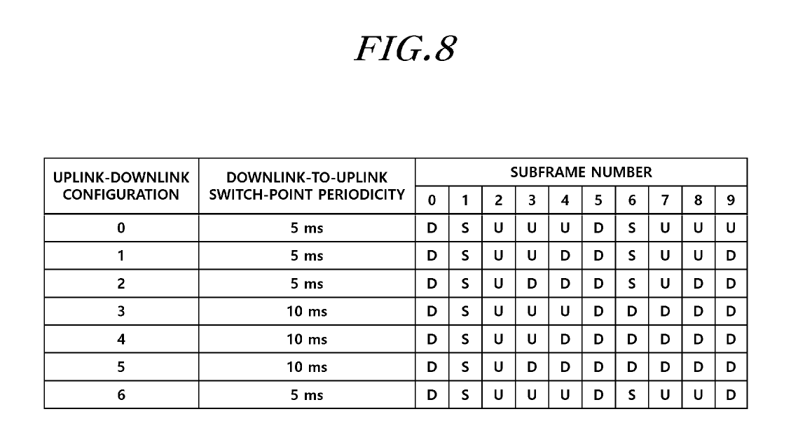

FIG. 8 is a table illustrating TDD UL-DL configurations in a TDD frame structure. In the Table of FIG. 8, D indicates DL subframes, U indicates UL subframes, and S indicates special subframes.

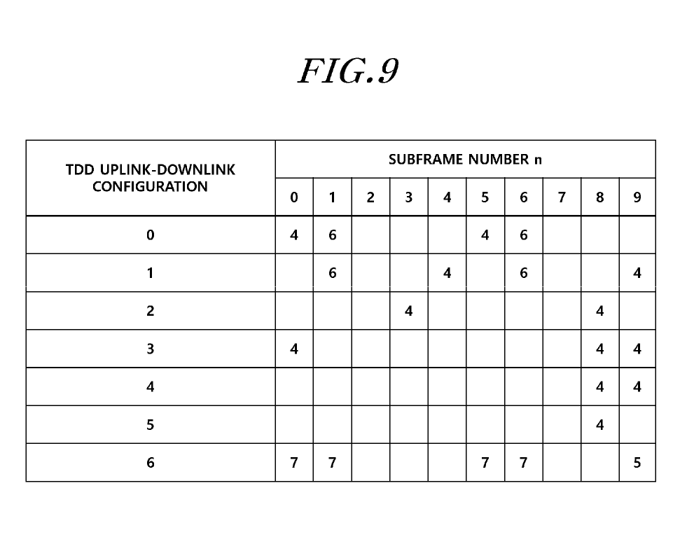

FIG. 9 is a table illustrating PDCCH/EPDCCH timing for TDD UL transmission in TDD UL-DL configurations.

FIG. 9 represents PDCCH/EPDCCH timing for TDD UL transmission in the existing TDD UL-DL configurations. This indicates that a PUSCH is transmitted on the (n+k)^{th} subframe regarding a PDCCH/EPDCCH on the relevant n^{th} subframe.

For example, regarding a PDCCH/EPDCCH and a PHICH detected on subframe 0 in TDD UL-DL configuration 0, a PUSCH can be transmitted on subframe 4. Regarding a PDCCH/EPDCCH and a PHICH detected on subframe 1 in TDD UL-DL configuration 1, a PUSCH can be transmitted on subframe 7.

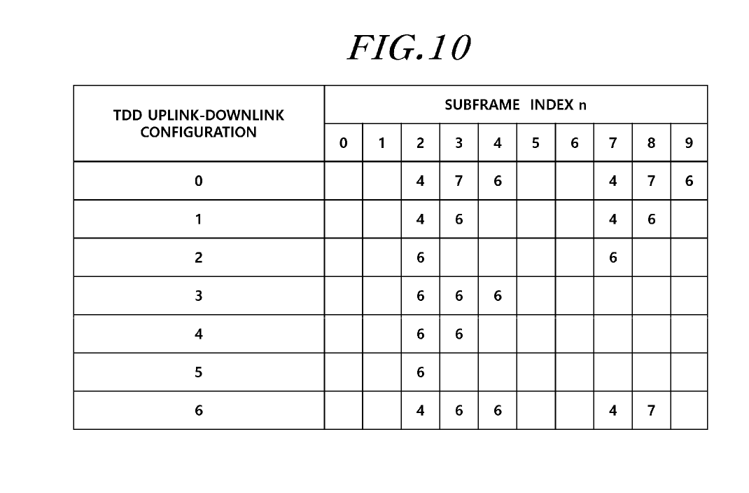

FIG. 10 is a table illustrating PHICH timing for TDD UL HARQ-ACK transmission in TDD UL-DL configurations.

FIG. 10 represents PHICH transmission timing for TDD UL HARQ-ACK transmission in the existing TDD UL-DL configurations. In PHICH timing regarding HARQ-ACK transmission for a PUSCH transmitted on subframe, a PHICH can be transmitted on the (n+k_PHICH)^{th} DL subframe.

In order to efficiently transmit and receive data, carrier aggregation (CA) in each of the FDD and TDD duplex modes is considered. However, there has been no consideration of the joint operation and CA between different duplex modes, i.e. FDD and TDD, proposed in the present disclosure.

Therefore, the present disclosure proposes a specific method and apparatus for control channel and PUSCH transmission timing and PHICH timing for HARQ-ACK transmission regarding UL transmission in case the joint operation and the CA of different FDD and TDD duplex modes are considered.

Specifically, embodiments of the present disclosure are applicable when a base station considers a joint operation of different duplex modes, i.e. FDD and TDD, and CA of FDD and TDD on a terminal. In this case, the terminal and the base station may operate differently from the event that CA is performed in the same duplex mode as in the related art. For example, it is necessary to differently define PUSCH transmission timing regarding the reception of a control channel (PDCCH/EPDCCH). In addition, it is necessary to differently define PHICH timing in which an HARQ-ACK in regarding UL transmission is transmitted. Thus, proposed are a method of operating a terminal in a relevant case, a method of establishing the operation of a terminal by a base station, and a terminal apparatus and a base station apparatus related thereto.

Hereinafter, according to embodiments, proposed are methods for operating a terminal and a base station regarding i) PUSCH transmission timing in response to the reception of a control channel (PDCCH/EPDCCH) and ii) PHICH timing for transmitting an HARQ-ACK in response to UL transmission when the joint operation and CA of different FDD and TDD duplex modes are considered.

At first, a method for controlling channel (PDCCH/EPDCCH) reception timing and consequent PUSCH transmission timing that may vary depending on the duplex modes of the cells designated as a PCell and an SCell in the TDD-FDD joint operation and CA will be described. In addition, in accordance with at least one embodiment of the present disclosure, UE procedures regarding PDCCH/EPDCCH timing for UL transmission and PHICH timing for transmitting a related HARQ-ACK in the TDD-FDD joint operation and CA.

In descriptions of the aggregation of carriers operating in different duplex modes or the joint operation of carriers operating in different duplex modes, the following embodiments be divided depending on the duplex modes of the PCell and the SCell.

TDD PCell and FDD SCell

While a TDD DL subframe designated for the TDD PCell is present in a specific subframe according to UL-DL configurations, all UL subframes for the FDD SCell are present in a single radio frame. In the case of non-cross-carrier scheduling, each of the TDD PCell and the FDD SCell performs self-carrier scheduling. Consequently, the TDD PCell and the FDD SCell can suitably operate as independent serving cells when control channel (PDCCH/EPDCCH) timing for UL transmission and PHICH timing for transmitting an HARQ-ACK

For example, when a terminal, in which a PCell and an SCell operating in different duplex modes are configured, transmits a PUSCH by receiving a control channel, in the case of self-carrier scheduling, the PUSCH can be transmitted on the control channel and PUSCH transmission timing established based on the duplex mode of each of the PCell and the SCell. That is, when the PCell is in the TDD or FDD duplex mode, the PUSCH can be transmitted in the PUSCH timing, on the TDD or FDD control channel. In the same manner, when the SCell is in the TDD or FDD duplex mode, the PUSCH can be transmitted in the PUSCH, on the TDD or FDD control channel.

In a terminal performing CA or a joint operation, cross-carrier scheduling is an operation in which one specific carrier performs scheduling by receiving and transmitting the control information of the other carriers. In addition, non-cross-carrier scheduling is an operation in which cross-carrier scheduling is not performed by one specific carrier because each carrier receives and transmits control information. Non-cross-carrier scheduling is also referred to as self-carrier scheduling since scheduling is performed by each carrier.

As described above, when the PCell is a TDD PCell and the SCell is an FDD SCell, in the case of self-carrier scheduling, the terminal and the base station can operate in PHICH timing according to the duplex modes thereof.

However, when cross-carrier scheduling is used, ambiguity may occur in the operations of the terminal and the base station. Specifically, cross-carrier scheduling is a technology applicable only to PCells according to the current standards. Thus, FDD SCell UL transmission is controlled by transmitting a PDCCH/EPDCCH for UL transmission for the FDD SCell in the TDD PCell. In such a case, there may be ambiguity as to whether the terminal transmits UL data in timing designated by the TDD PCell or transmits UL data based on FDD timing relationship according to the FDD SCell.

For example, in HARQ timing regarding UL transmission in the existing FDD SCell, a UL is transmitted on the n^{th} subframe using a UL grant received from the existing (n−4)^{th} subframe, and the PHICH timing of the HARQ-ACK transmitted on the (n+4)^{th} subframe is used. Thus, cross-carrier scheduling has a problem in that, when the TDD PCell has no (n−4)^{th} DL subframe with respect to the n^{th} UL transmission, scheduling of the relevant UL using the PDCCH/EPDCCH is disabled.

In addition, similarly, there is a problem in that, when the TDD PCell has no (n+4)^{th} DL subframe with respect to the n^{th} UL transmission, a PHICH on which an HARQ-ACK regarding the relevant UL is transmitted cannot be received.

Thus, for a terminal allowing the TDD-FDD joint operation and CA, it is necessary to have a method for improving i) timing for transmitting a UL grant that transmits the scheduling information of a PDCCH/EPDCCH for a UL transmission regarding the relevant FDD SCell and ii) timing for transmitting PHICH that transmits an HARQ-ACK regarding the relevant UL transmission.

Hereinafter, embodiments of the present disclosure in which the duplex mode of the PCell is TDD and the duplex mode of the SCell is FDD will be described in detail.

### First Embodiment

### A Method of Synchronizing Control Channel Timing and PUSCH Timing for Transmitting UL to a FDD SCell with Timing of a TDD PCell

According to the first embodiment of the present disclosure, when a terminal that has established a TDD PCell adds an FDD SCell for TDD-FDD joint operation and CA, the terminal can set up PDCCH/EPDCCH timing for a UL transmission regarding the FDD SCell according to the TDD PCell. In the meantime, a method of applying the timing of the TDD PCell as the PHICH timing on which the HARQ-ACK regarding the UL transmission to the FDD SCell may be considered.

Specifically, regarding a PDCCH/EPDCCH that has scheduling information (e.g., grant) on the (n−4)^{th} subframe established in the existing FDD-FDD CA of the FDD SCell, the terminal can transmit a PUSCH on the n^{th} subframe. In addition, the terminal can establish PDCCH/EPDCCH timing and PHICH timing regardless of whether the relevant HARQ-ACK is established to be transmitted on the PHICH to the DL (n+4)^{th} subframe, which is the PHICH transmission timing of the existing FDD. That is, the PDCCH/EPDCCH reception timing for a TDD UL shared channel associated with UL-DL subframe configurations used by the TDD PCell and the PHICH timing in which the HARQ-ACK is transmitted are applied to the FDD SCell. This scheme is applied as if the TDD SCell is added to the FDD SCell. That is, the PUSCH transmission of the SCell can be performed based on the timing of the UL-DL subframe configurations established to be used in the TDD PCell. In other words, the PUSCH transmission of the SCell can be performed based on a control channel received in control channel reception timing for a UL established to be used in the PCell.

When the first embodiment of the present disclosure is applied in this manner, it is possible to reduce the problem in that there is no DL subframe of the TDD PCell for scheduling a UL of the n^{th} subframe regarding the above-described FDD SCell or there is no DL subframe on the TDD PCell for receiving the PHICH of the HARQ-ACK regarding a UL transmitted on a specific subframe.

### Second Embodiment

### A Method of Synchronizing Control Channel and PUSCH Timing for Transmitting UL to a FDD SCell with Timing of a FDD PCell

In a specific UL-DL configuration established in a specific TDD PCell as in the above-described first embodiment, when PHICH timing for transmitting a UL signal on a UL subframe in an FDD SCell is synchronized with the timing of the TDD PCell, the subframe of the SCell may be wasted, which is problematic.

For example, when timing in which a PDCCH/EPDCCH regarding a UL transmitted from the FDD SCell is received and/or PHICH timing in which an HARQ-ACK in response to UL transmission is received follow the timing of the PCell according to UL-DL configurations, UL subframes of the FDD SCell aligned with DL subframes of the TDD PCell for UL transmission have a problem in that there is no timing information related to the PDCCH/EPDCCH and the PHICH, since the relevant subframes of the existing TDD PCell are DL subframes. That is, regarding the UL PUSCH to be transmitted using an FDD SCell UL subframe index the same as the DL subframe index of the TDD PCell, there is neither scheduling grant timing nor PHICH timing from the TDD DL subframes. Thus, the terminal cannot transmit UL subframes of the relevant FDD SCell. This may reduce UL data transmission rates by about 40% to about 90% according to UL-DL configurations designated to each TDD PCell.

Specifically, subframes without timing in the FDD SCell according to TDD PCell configurations will be described with reference to the drawings.

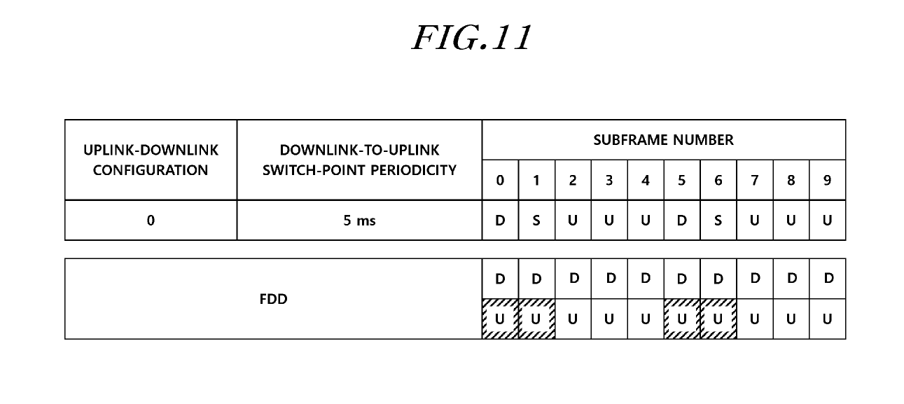

FIG. 11 to FIG. 17 illustrate exemplary cases in which a TDD cell and an FDD cell are subjected to CA, the TDD cell having TDD UL-DL configurations 0 to 6 for TDD-FDD joint operation and CA.

Each of FIG. 11 to FIG. 17 represents an exemplary case in which the TDD cell and the FDD Cell are subjected to CA, the TDD cell having TDD UL-DL configurations 0 to 6 for TDD-FDD joint operation and CA. In addition, in the FDD Cell, the UL frequency bands of some subframes are hatched. In TDD-FDD joint operation and CA, the hatched subframes require additional establishment of PDCCH/EPDCCH timing regarding an FDD SCell UL transmission and PHICH timing in which an HARQ-ACK in response to the FDD SCell UL transmission is transmitted. That is, in application to the above-described first embodiment, these subframes require new establishment regarding the PDCCH/EPDCCH timing and the PHICH timing in the FDD SCell.

FIG. 11 is a table illustrating a case in which a TDD Cell having TDD UL-DL configuration 0 and an FDD Cell are subjected to CA according to an embodiment of the present disclosure. Referring to FIG. 11, subframes of the TDD PCell, the indices of which are the same as those of subframes 0, 1, 5, and 6 of the FDD SCell, are established as DL or special subframes. Thus, when the FDD SCell is established to follow the PDCCH/EPDCCH timing and the PHICH timing of the TDD PCell according to the above-described first embodiment, UL signal transmission cannot be performed on subframes 0, 1, 5, and 6 of the FDD Cell. Such a problem causes a waste of the subframes of the FDD SCell.

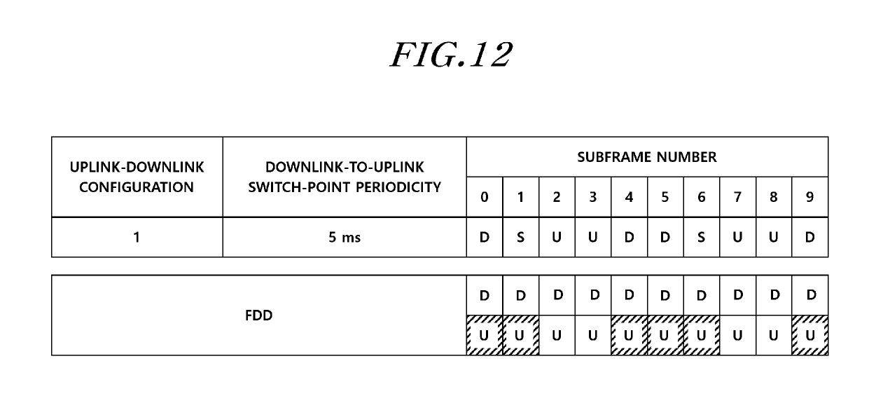

FIG. 12 is a table illustrating a case in which a TDD Cell having TDD UL-DL configuration 1 and an FDD Cell are subjected to CA according to an embodiment of the present disclosure. Referring to FIG. 12, subframes of the TDD PCell, the indices of which are the same as those of subframes 0, 1, 4, 5, 6, and 9 of the FDD SCell, are established as DL or special subframes. Thus, when the FDD SCell is established to follow the PDCCH/EPDCCH timing and the PHICH timing of the TDD PCell according to the above-described first embodiment, UL signal transmission cannot be performed on subframes 0, 1, 4, 5, 6, and 9 of the FDD Cell are disabled. Such a problem causes a waste of the subframes of the FDD SCell.

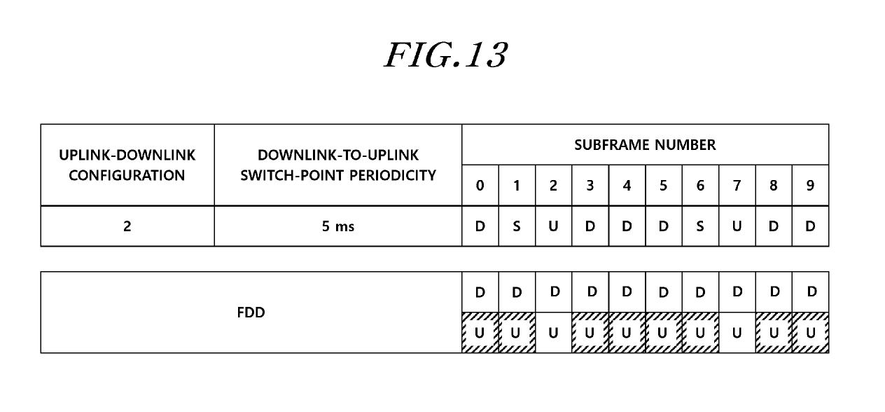

FIG. 13 is a table illustrating a case in which a TDD Cell having TDD UL-DL configuration 2 and an FDD Cell are subjected to CA according to an embodiment of the present disclosure. Referring to FIG. 13, subframes of the TDD PCell, the indices of which are the same as those of subframes 0, 1, 3, 4, 5, 6, 8, and 9 of the FDD SCell, are established as DL or special subframes. Thus, when the FDD SCell is established to follow the PDCCH/EPDCCH timing and the PHICH timing of the TDD PCell according to the above-described first embodiment, UL signal transmission cannot be performed on subframes 0, 1, 3, 4, 5, 6, 8, and 9 of the FDD Cell. Such a problem causes a waste of the subframes of the FDD SCell.

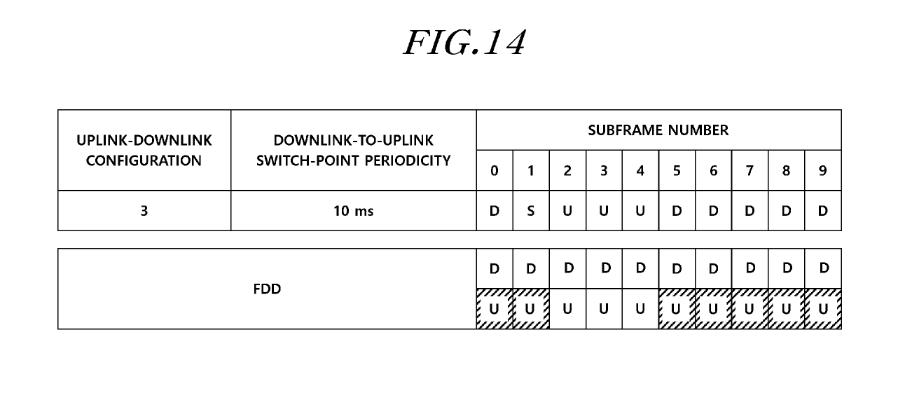

FIG. 14 is a table illustrating a case in which a TDD Cell having TDD UL-DL configuration 3 and an FDD Cell are subjected to CA according to an embodiment of the present disclosure. Referring to FIG. 14, subframes of the TDD PCell, the indices of which are the same as those of subframes 0, 1, 5, 6, 7, 8, and 9 of the FDD SCell, are established as DL or special subframes. Thus, when the FDD SCell is established to follow the PDCCH/EPDCCH timing and the PHICH timing of the TDD PCell according to the above-described first embodiment, UL signal transmission cannot be performed on subframes 0, 1, 5, 6, 7, 8, and 9 of the FDD Cell. Such a problem causes a waste of the subframes of the FDD SCell.

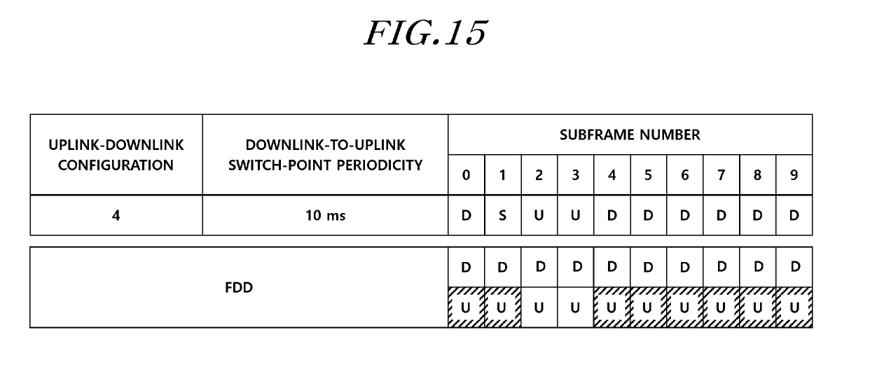

FIG. 15 is a table illustrating a case in which a TDD Cell having TDD UL-DL configuration 4 and an FDD Cell are subjected to CA according to an embodiment of the present disclosure. Referring to FIG. 15, subframes of the TDD PCell, the indices of which are the same as those of subframes 0, 1, 4, 5, 6, 7, 8, and 9 of the FDD SCell, are established as DL or special subframes. Thus, when the FDD SCell is established to follow the PDCCH/EPDCCH timing and the PHICH timing of the TDD PCell according to the above-described first embodiment, UL signal transmission cannot be performed on subframes 0, 1, 4, 5, 6, 7, 8, and 9 of the FDD Cell. Such a problem causes a waste of the subframes of the FDD SCell.

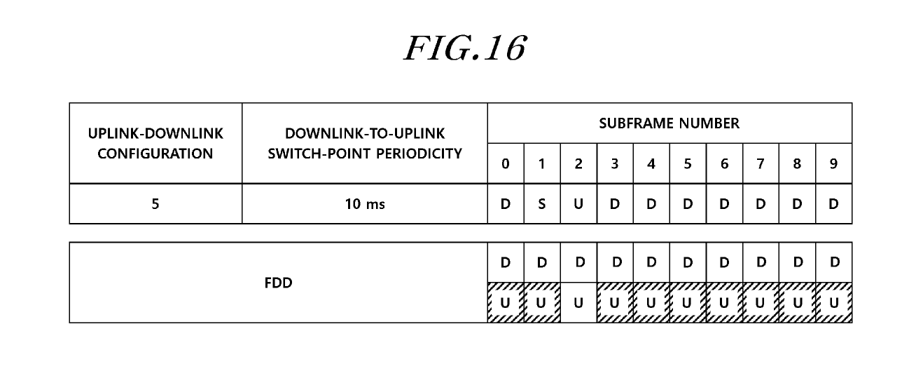

FIG. 16 is a table illustrating a case in which a TDD Cell having TDD UL-DL configuration 5 and an FDD Cell are subjected to CA according to an embodiment of the present disclosure. Referring to FIG. 16, subframes of the TDD PCell, the indices of which are the same as those of subframes 0, 1, 3, 4, 5, 6, 7, 8, and 9 of the FDD SCell, are established as DL or special subframes. Thus, when the FDD SCell is established to follow the PDCCH/EPDCCH timing and the PHICH timing of the TDD PCell according to the above-described first embodiment, UL signal transmission cannot be performed on subframes 0, 1, 3, 4, 5, 6, 7, 8, and 9 of the FDD Cell. Such a problem causes a waste of the subframes of the FDD SCell.

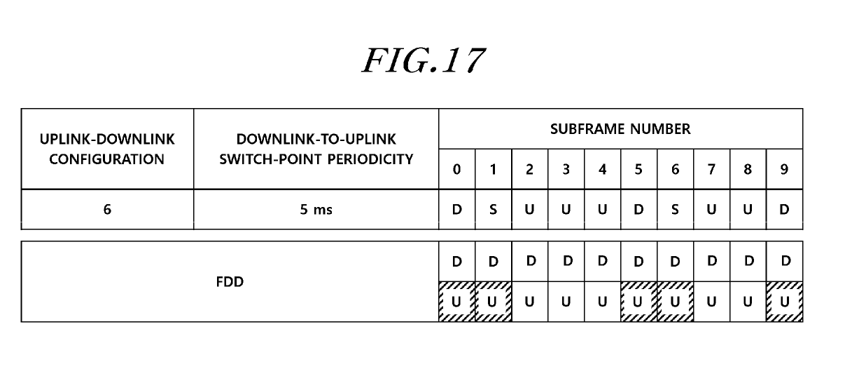

FIG. 17 is a table illustrating a case in which a TDD Cell having TDD UL-DL configuration 6 and an FDD Cell are subjected to CA according to an embodiment of the present disclosure. Referring to FIG. 17, subframes of the TDD PCell, the indices of which are the same as those of subframes 0, 1, 5, 6, and 9 of the FDD SCell, are established as DL or special subframes. Thus, when the FDD SCell is established to follow the PDCCH/EPDCCH timing and the PHICH timing of the TDD PCell according to the above-described first embodiment, UL signal transmission cannot be performed on subframes 0, 1, 5, 6, and 9 of the FDD Cell. Such a problem causes a waste of the subframes of the FDD SCell.

If the FDD SCell is added as described above, when the SCell establishes the PDCCH/EPDCCH timing and the PHICH timing according to the configurations of the TDD PCell as in the above-described first embodiment, some of the UL subframes of the FDD SCell may operate abnormally.

In order to overcome such a shortcoming, the second embodiment of the present disclosure provides a method of defining reception timing for receiving a control channel for additional UL transmission regarding the UL of the relevant FDD SCell and HARQ-ACK PHICH timing for the UL.

Such a control channel reception timing according to the second embodiment of the present disclosure may follow the timing of the FDD SCell. That is, the PUSCH transmission of the SCell may be performed based on a control channel received in the control channel reception timing for a UL established to be used in the SCell. For example, the control channel (PDCCH/EPDCCH) reception timing in the TDD PCell in which the PUSCH transmission is performed on the n^{th} UL subframe of the FDD SCell can be established such that the PUSCH transmission instructed due to the detection of the control channel (PDCCH/EPDCCH) in a subframe of the TDD PCell prior to at least (n−4)^{th} subframe. Regarding the PHICH on which the HARQ-ACK in response to the PUSCH transmitted on the n^{th} n UL subframe is transmitted, the earliest PHICH transmission may be established to be transmitted on at least (n+4)^{th} TDD PCell DL subframe. That is, the control channel (i.e. the PDCCH/EPDCCH) including UL grant information about the PUSCH transmitted to the FDD SCell can be received at an interval of 4 ms or 4 TTI from the relevant PUSCH.

Timing Relationship Between PUSCH and PDCCH/EPDCCH Transmitted to SCell

Table 1 shows an example of the timing relationship of the PDCCH/EPDCCH for UL data transmission on the TDD PCell according to an embodiment of the present disclosure.

TABLE 1

| TDD UL-DL | | | | | | | | | | |
|---|---|---|---|---|---|---|---|---|---|---|
| Configu- | Subframe number n | | | | | | | | | |
| ration | 0 | 1 | 2 | 3 | 4 | 5 | 6 | 7 | 8 | 9 |
| 0 | 4,5 | 6,5 | | | | 4,5 | 6,5 | | | |
| 1 | 4,5 | 6,5 | | | 4 | 4,5 | 6,5 | | | 4 |
| 2 | 4 | 4,5 | | 4 | 4 | 4 | 5,4 | | 4 | 4 |
| 3 | 4,6 | 7,6 | | | | 4 | 4 | 4 | 4 | 4,6 |
| 4 | 5,4 | 6,5 | | | 4 | 4 | 4 | 4 | 4 | 4 |
| 5 | 4 | 5,4 | | 4 | 4 | 4 | 4 | 4 | 4 | 4 |
| 6 | 7,5 | 7,5 | | | | 7,4 | 7,5,4 | | | 5 |

Referring to Table 1, the PDCCH/EPDCCH for the FDD SCell PUSCH can be transmitted by being equally distributed on TDD DL subframes. Specifically, after the detection of the PDCCH/EPDCCH on TDD PCell subframes, PUSCH transmission timing may be as in Table 1. This indicates that, if the UL PDCCH/EPDCCH transmission regarding the FDD SCell is performed on the TDD PCell (cross-carrier scheduling), the PUSCH is transmitted on the (n+k)^{th} subframe in the FDD SCell by the PDCCH/EPDCCH detected on the relevant n^{th} subframe in the TDD PCell.

For example, underlined k values according to respective TDD UL-DL configurations are portions that newly define additional timing in existing TDD configurations. That is, in the case of TDD UL-DL configuration 0, the PDCCH/EPDCCH received on subframe 0 was able to include PUSCH scheduling information on a fourth UL subframe, i.e. the (n+4)^{th} UL subframe, of the TDD Cell. When the FDD SCell according to the present disclosure is added, subframe 0 in TDD UL-DL configurations may be established by adding 5 as a k value in order to schedule the PUSCH in FDD subframe 5. Therefore, the PUSCH can be scheduled on subframe 5 of the FDD SCell, based on the PDCCH/EPDCCH received on subframe 0 of the TDD PCell.

Table 1 represents exemplary timing information of the PUSCH and the PDCCH/EPDCCH about the FDD SCell according to TDD UL-DL configurations. Thus, timing of transmitting a PUSCH in the SCell according to TDD UL-DL configurations may be independent. Although seven sets are illustrated in a single table for the sake of explanation, they may be separately defined. That is, PUSCH transmission timing data of the SCell according to TDD UL-DL configurations in Table 1 may be defined separately.

The definition of the PDCCH/EPDCCH timing for the PUSCH transmitted on the FDD SCell UL subframe, described above with reference to Table 1, is an example for equally distributing and transmitting PDCCH/EPDCCH for FDD Scell PUSCH on TDD DL subframes.

On the other hand, the PDCCH/EPDCCH timing for the FDD SCell PUSCH may be established to be allocated to a specific a specific TDD DL subframe.

Table 2 and Table 3 represent exemplary timing relationships of the PDCCH/EPDCCH when TDD UL-DL configuration 0 according to another embodiment of the present disclosure is a PCell.

TABLE 2

| TDD UL/DL | | | | | | | | | |
|---|---|---|---|---|---|---|---|---|---|
| Configu- | Subframe number n | | | | | | | | |
| ration | 0 | 1 | 2 | 3 | 4 | 5 | 6 | 7 | 8 |
| 0 | 4,5,6 | 6 | | | 4,5,6 | 6 | | | |

TABLE 3

| TDD UL/DL | | | | | | | | | |
|---|---|---|---|---|---|---|---|---|---|
| Configu- | Subframe number n | | | | | | | | |
| ration | 0 | 1 | 2 | 3 | 4 | 5 | 6 | 7 | 8 |
| 0 | 4 | 6,5,4 | | | 4 | 6,5,4 | | | |

Referring to Table 2 and Table 3, when TDD UL-DL configuration 0 is the PCell, the PDCCH/EPDCCH for a UL PUSCH of the relevant FDD SCell may be concentrically allocated to a specific TDD DL subframe. For example, in the case of the TDD PCell having TDD UL-DL configuration 0 as in Table 2, k values of subframe 0 may be established to be 4, 5, and 6. In this case, the PDCCH/EPDCCH received on subframe 0 may include the PUSCH scheduling information of the (n+k)^{th} subframe. Therefore, the PDCCH/EPDCCH may include the PUSCH scheduling information of UL subframes 5 and 6 of the FDD SCell.

As another example, referring to Table 3, the PUSCH scheduling information of UL subframes 5 and 6 of the FDD SCell may be received on subframe 1 of the TDD PCell.

In this manner, control information for scheduling the PUSCH of UL subframes of the SCell, which has not been able to be scheduled by the existing TDD UL-DL configuration, can be established to be concentrically allocated to a specific subframe of the TDD PCell.

Although TDD configuration 0 was described by way of example, the same principle can be applied to the other TDD UL-DL configurations. In the case of concentric allocation, subframe index information by which the relevant PUSCH is intended to be transmitted may be transmitted on the PDCCH/EPDCCH. That is, it is possible to establish the PUSCH to be transmitted on the relevant UL subframe by indicating a UL subframe index regarding the relevant FDD SCell with UL index information.

Hereinabove, according to the second embodiment of the present disclosure, the method of additionally establishing the PUSCH timing and the PDCCH/EPDCCH timing to be equally or concentrically established has been described.

FDD PCell and TDD SCell

According to another embodiment of the present disclosure, a case in which the duplex mode of the PCell is FDD and the duplex mode of the SCell is TDD may be considered. When the PCell and the SCell are subjected to self-carrier scheduling, the terminal can transmit a PUSCH based on control channel reception timing according to the duplex modes of the PCell and the SCell.

When cross-carrier scheduling is applied, according to the embodiments, control channel reception timing regarding the PUSCH transmitted from the TDD SCell may be established as follows in order to reduce a waste in subframes and efficiently transmit the PUSCH.

### Third Embodiment

### Method of Applying Control Channel Reception Timing and PUSCH Timing of TDD SCell

For example, a SCell operating in TDD duplex mode may be added to a PCell operating in FDD duplex mode. In this case, UL subframe scheduling for the TDD SCell may be performed from DL subframes of the FDD PCell.

When cross-carrier scheduling is performed in this manner, all subframes of a single radio frame in the FDD PCell are DL subframes, and a UL grant for the TDD SCell is transmitted from the FDD PCell that is performing cross-carrier scheduling. In addition, a PHICH, on which an HARQ-ACK in response to UL transmission from the TDD SCell is transmitted, is received on the FDD PCell.

Therefore, timing established based on the TDD duplex mode of the SCell may be applied as timing for UL PUSCH transmission from the TDD SCell and control channel reception timing. In the meantime, the PHICH timing may be established such that TDD ULPHICH timing used in non-cross-carrier scheduling is applicable thereto. That is, the timing for the UL PHICH transmission from the TDD SCell may be established to follow FIG. 10 as described above.

Accordingly, the PHICH timing according to further another embodiment of the present disclosure is established to be the same as the PHICH timing illustrated in FIG. 10 such that the same PHICH timing is applied in non-cross-carrier scheduling and cross-carrier scheduling. According to the establishment as above, when the TDD duplex mode is included, the terminal can operate in the same PHICH timing commonly in TDD-TDD CA and TDD-FDD CA.

In the same manner, control channel reception timing and timing for PUSCH transmission to the SCell may be applied according to TDD UL-DL configurations of the SCell as in non-cross-carrier scheduling. That is, control channel reception timing and timing for PUSCH transmission to the SCell may be applied according to the timing table in FIG. 9. In other words, the PUSCH transmission from the SCell may be performed based on a control channel received in UL control channel reception timing established to be used in the SCell.

### Fourth Embodiment

### Method of Applying Control Channel Reception Timing and PUSCH Timing of FDD PCell

Different from the third embodiment, when cross-carrier scheduling is performed, the timing of the FDD PCell may be applied as control channel reception timing for PUSCH transmission to the TDD SCell and PUSCH transmission timing in response to the reception of a control channel. That is, the PUSCH transmission from the SCell may be performed based on the control channel received in UL control channel reception timing established to be used in the PCell. For example, the PDCCH/EPDCCH of the PUSCH transmitted on the n^{th} subframe may be received on the (n−4)^{th} subframe. Alternatively, the PDCCH/EPDCCH may be established to be received on at least (n−4)^{th} subframe.

Specifically, for example, in the case of cross-carrier scheduling, a UL grant for the TDD SCell is transmitted on (n−k)^{th} subframe from the FDD PCell. Thus, a terminal that has received the UL grant can transmit the UL on the n^{th} subframe to the TDD SCell. For example, k may be 4. In the meantime, after the UL is transmitted on the n^{th} subframe to the TDD SCell, a PHICH may be received on PHICH timing established by the FDD PCell. That is, the PHICH may be received on the (n+k_PHICH)^{th} DL subframe of the FDD PCell, where k_PHICH=4 for FDD.

In this case, a method able to establish PUSCH timing and PHICH timing for UL transmission to the TDD SCell to be synchronous with the FDD PCell and establish the PHICH timing to FDD-FDD CA and FDD-TDD CA regardless of different duplex modes may be considered.

The first to fourth embodiments of the present disclosure as described above are scenarios used in a TDD-FDD joint operation and a CA operation, applicable to both a case in which CA is used via two or more component carriers and a case in which CA cannot be used in the UL, i.e. a single component carrier is used.

Hereinafter, operations of a terminal and a base station in accordance with at least one embodiment will be described with reference to the accompanying drawings.

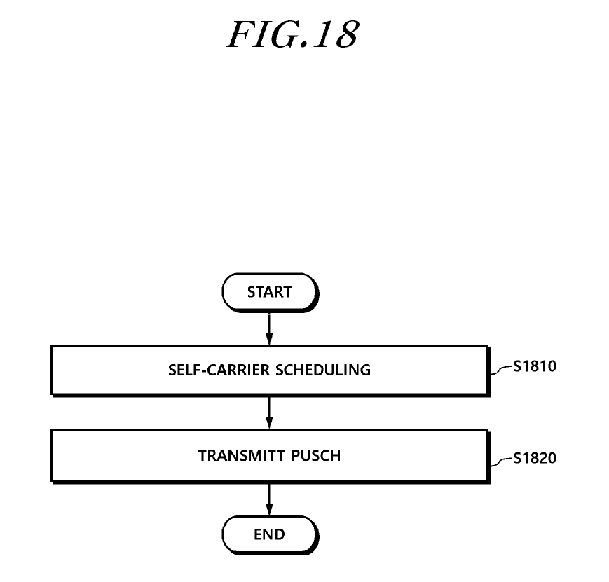

FIG. 18 is a diagram illustrating an exemplary operation when a terminal tis self-carrier scheduled according to another embodiment of the present disclosure.

In accordance with another embodiment of the present disclosure, a method may be provided for processing a control channel by a terminal, when PCell and an SCell operate in different duplex modes. The method may include: establishing each of the PCell and the SCell to perform self-carrier scheduling; and transmitting a PUSCH to each of the PCell and the SCell based on a control channel received in control channel reception timing for receiving a control channel for transmitting UL at the duplex mode of each of the PCell and the SCell.

Referring to FIG. 18, at S1810, the terminal configured with the PCell and the SCell operating in different duplex modes performs self-scheduling. For example, a control channel including a UL grant for PUSCH transmission of each of the PCell and the SCell can be transmitted from each of the PCell and the SCell. The terminal can receive the control channel transmitted from each of the cells and perform PUSCH transmission of each of the cells.

At S1820, the PUSCH is transmitted to each of the PCell and the SCell based on the control channel received in control channel reception timing which is timing of receiving a control channel for UL transmission in the duplex mode of each of the PCell and the SCell. For example, the terminal can transmit the PUSCH to the PCell based on the control channel and the PUSCH timing according to the duplex mode of the PCell. In addition, the PUSCH can be transmitted to the SCell based on the control channel and the PUSCH timing according to the duplex mode of the SCell.

Thus, according to the embodiment of the present disclosure, the PUSCH can be transmitted in the timing based on the duplex mode of the relevant cell regardless of whether the duplex mode of the PCell is TDD or FDD. For example, the control channel may be PDCCH/EPDCCH.

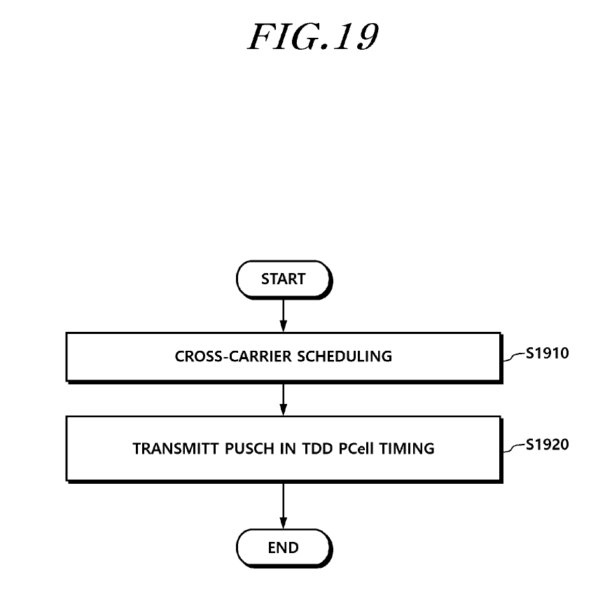

FIG. 19 is a diagram illustrating an exemplary operation when a terminal is cross-carrier scheduled according to further another embodiment of the present disclosure.

In accordance with further another embodiment of the present disclosure, a method may be provided for processing a control channel by a terminal configured with a PCell operating in TDD duplex mode and an SCell operating in FDD duplex mode. The method includes: performing cross-carrier scheduling on the SCell from the PCell; and transmitting a PUSCH to the SCell based on a control channel received from the PCell in control channel reception timing which is timing of receiving a control channel for UL transmission according to the duplex mode of the PCell.

Referring to FIG. 19, at S1910, the terminal is configured with the PCell operating in the TDD duplex mode and the SCell operating in the FDD duplex mode, and the terminal allows the SCell to be cross-carrier scheduled from the PCell. For example, the control channel transmitted from the PCell includes the UL grant information of the SCell. The terminal can control the PUSCH transmission of the SCell based on information included in the control channel transmitted from the PCell.

In this case, at S1920, the terminal can transmit the PUSCH to the SCell based on the control channel received from the PCell in the control channel reception timing which is timing of receiving a control channel for UL transmission according to the duplex mode of the PCell. For example, the PUSCH can be transmitted to the SCell based on the control channel of the PCell operating in the TDD duplex mode and PUSCH transmission timing. That is, PUSCH transmission subframes can be determined according to the TDD UL-DL configurations of the PCell, as illustrated in FIG. 9.

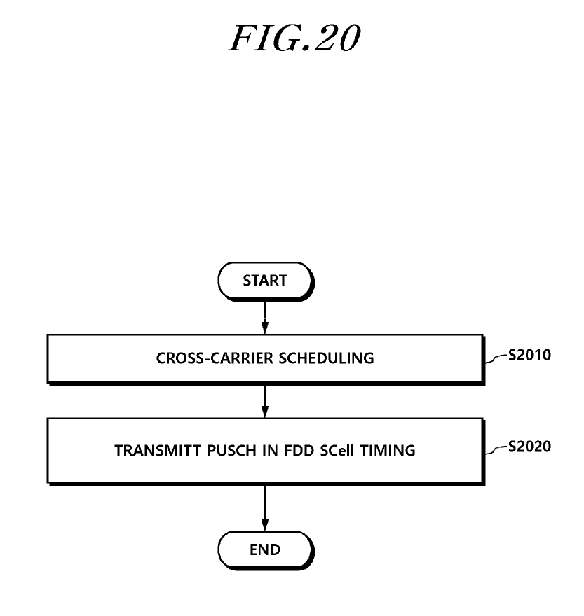

FIG. 20 is a diagram illustrating an exemplary operation of a terminal cross-carrier scheduled according to further another embodiment of the present disclosure.

In accordance with further another embodiment of the present disclosure, a method may be provided for processing a control channel by a terminal configured with a PCell operating in TDD duplex mode and an SCell operating in FDD duplex mode. The method may include: performing cross-carrier scheduling on the SCell from the PCell; and transmitting a PUSCH to the SCell based on a control channel received from the PCell in control channel reception timing that is timing of receiving a control channel for UL transmission according to the duplex mode of the SCell.

Referring to FIG. 20, at S2010, the terminal is configured with the PCell operating in the TDD duplex mode and the SCell operating in the FDD duplex mode, and the terminal allows the SCell to be cross-carrier scheduled from the PCell. For example, the control channel transmitted from the PCell includes the UL grant information of the SCell. The terminal can control the PUSCH transmission of the SCell based on information included in the control channel transmitted from the PCell.

In this case, at S2020, the terminal can transmit the PUSCH to the SCell based on the control channel received from the PCell in the control channel reception timing that is timing of receiving a control channel for UL transmission according to the duplex mode of the Scell. For example, the relevant PUSCH can be transmitted to the SCell based on the control channel of the SCell operating in the FDD duplex mode and PUSCH transmission timing. For example, the control channel including the UL grant regarding the PUSCH transmitted on the n^{th} subframe may be received on the (n−4)^{th} subframe. That is, the control channel received from the PCell and the PUSCH transmitted to the SCell may have an interval of 4 ms. Alternatively, the interval may be 4 TTI.

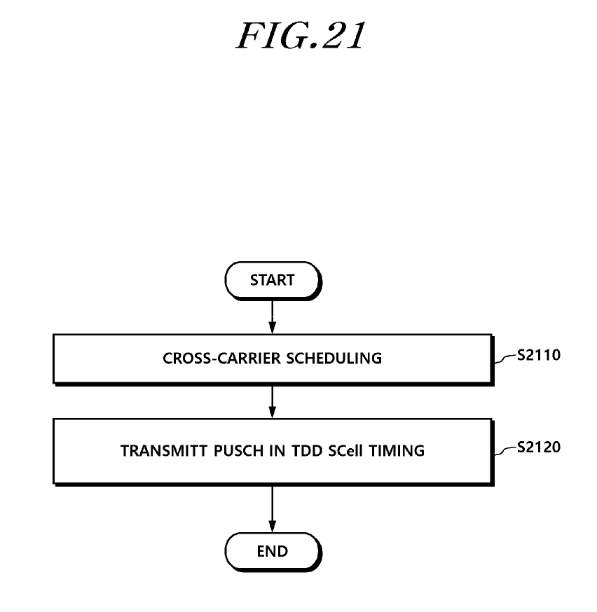

FIG. 21 is a diagram illustrating an exemplary operation when a terminal is cross-carrier scheduled according to another embodiment of the present disclosure.

In accordance with another embodiment of the present disclosure, a method may be provided for processing a control channel by a terminal configured with a PCell operating in FDD duplex mode and an SCell operating in TDD duplex mode. The method includes: performing cross-carrier scheduling on the SCell from the PCell; and transmitting a PUSCH to the SCell based on a control channel received from the PCell in control channel reception timing which is timing of receiving a control channel for UL transmission according to the duplex mode of the SCell.

Referring to FIG. 21, at S2110, the terminal is configured with the PCell operating in the FDD duplex mode and the SCell operating in the TDD duplex mode, and the terminal allows the SCell to be cross-carrier scheduled from the PCell. For example, the control channel transmitted from the PCell includes the UL grant information of the SCell. The terminal can control the PUSCH transmission of the SCell based on information included in the control channel transmitted from the PCell.

In this case, at S2120, the PUSCH can be transmitted to the SCell based on the control channel received from the PCell in the control channel reception timing which is timing of receiving a control channel for UL transmission according to the duplex mode of the SCell. For example, the relevant PUSCH can be transmitted to the SCell based on the control channel of the SCell operating in the TDD duplex mode and PUSCH transmission timing. That is, PUSCH transmission subframes can be determined according to the TDD UL-DL configurations of the PCell, as illustrated in FIG. 9.

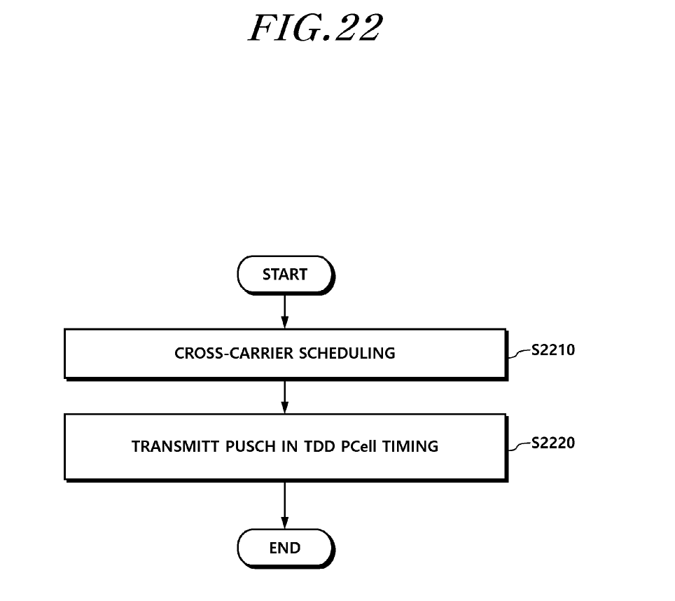

FIG. 22 is a diagram illustrating an exemplary operation when a terminal is cross-carrier scheduled according to further another embodiment of the present disclosure.

In accordance with further another embodiment of the present disclosure, a method may be provided for processing a control channel by a terminal configured with a PCell operating in FDD duplex mode and an SCell operating in TDD duplex mode. The method may include: performing cross-carrier scheduling on the SCell from the PCell; and transmitting a PUSCH to the SCell based on a control channel received from the PCell in control channel reception timing which is timing of receiving a control channel for UL transmission according to the duplex mode of the PCell.

Referring to FIG. 22, at S2210, the terminal is configured with the PCell operating in the FDD duplex mode and the SCell operating in the TDD duplex mode, and the terminal allows the SCell to be cross-carrier scheduled from the PCell. For example, the control channel transmitted from the PCell includes the UL grant information of the SCell. The terminal can control the PUSCH transmission of the SCell based on information included in the control channel transmitted from the PCell.

In this case, at S2220, the terminal can transmit the PUSCH to the SCell based on the control channel received from the PCell in the control channel reception timing which is timing of receiving a control channel that transmit UL according to the duplex mode of the PCell. For example, the control channel including the UL grant regarding the PUSCH transmitted from the n^{th} subframe can be received on the (n−4)^{th} subframe. That is, the control channel received from the PCell and the PUSCH transmitted to the SCell may be established to have an interval of 4 ms. Alternatively, the interval may be 4 TTI.

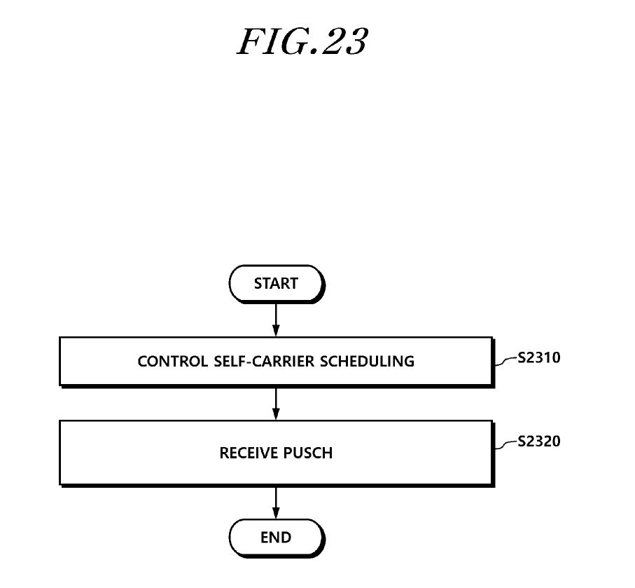

FIG. 23 to FIG. 27 are diagrams illustrating operations of a base station according to embodiments of the present disclosure.

FIG. 23 is a diagram illustrating an exemplary operation of a base station when a terminal is self-carrier scheduled according to another embodiment of the present disclosure.

In accordance with another embodiment of the present disclosure, a method may be provided for controlling, in a base station, PUSCH transmission of a terminal configured with a PCell and a SCell operating in different duplex modes. The method may include: controlling each of the PCell and the SCell to be self-carrier scheduled; and receiving a PUSCH transmitted to each of the PCell and the SCell based on a control channel transmitted from each of the PCell and the SCell in control channel reception timing which is timing for receiving a control channel for UL transmission in the duplex mode of each of the PCell and the SCell.

Referring to FIG. 23, at S2310, the base station can control the terminal to be self-carrier scheduled. Here, control information is transmitted to the terminal, in which the PCell and the SCell operating in different duplex modes are configured. For example, control information regarding the PCell can be transmitted to the control channel of the PCell, and control information regarding the SCell can be transmitted to the control channel of the SCell. Consequently, the terminal can perform self-carrier scheduling as described above based on the received control information.

At S2320, the base station can receive the PUSCH transmitted to each of the PCell and the SCell based on the control channel transmitted from each of the PCell and the SCell in control channel reception timing for UL transmission in the duplex mode of each of the PCell and the SCell. For example, when the terminal transmits the PUSCH to the PCell based on the information of the control channel transmitted to the PCell, the base station can receive the information. In addition, when the PUSCH is transmitted to the SCell based on the information of the control channel transmitted to the SCell, the base station can receive the information. In this case, the control channel reception timing and the PUSCH transmission timing of each of the cells may be timing established according to the duplex mode of each of the cells. For example, when the PCell operates in the TDD duplex mode, the PUSCH received in the PCell may be transmitted based on the control channel defined according to UL-DL configurations, as represented in FIG. 9, and the PUSCH transmission timing. Likewise, when the SCell operates in the FDD duplex mode, the PUSCH received in the SCell may be transmitted based on FDD timing. That is, when the PDCCH/EPDCCH including information regarding PUSCH transmission of the SCell is transmitted on the n^{th} subframe, the received PUSCH is transmitted on the (n+4)^{th} subframe.

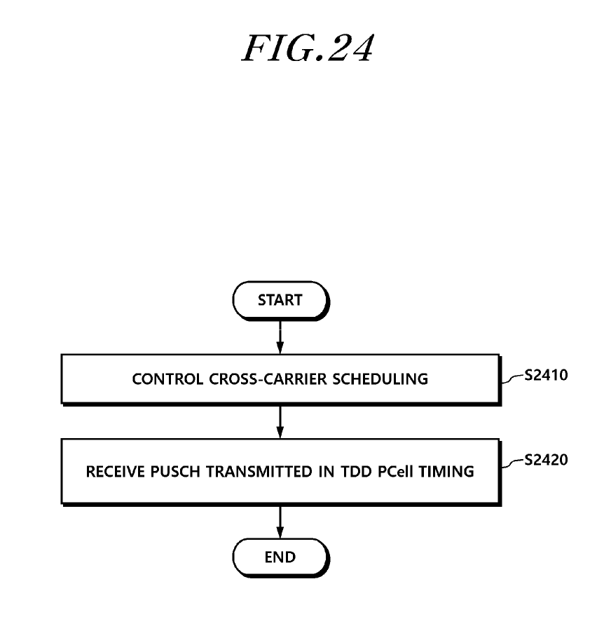

FIG. 24 is a diagram illustrating an exemplary operation of a base station when a terminal is cross-carrier scheduled according to further another embodiment of the present disclosure.

In accordance with further another embodiment of the present disclosure, a method may be provided for controlling, in a base station, PUSCH transmission of a terminal configured with a PCell operating in TDD duplex mode and a SCell operating in FDD duplex mode. The method includes: controlling the PCell to perform cross-carrier scheduling on the SCell; and receiving a PUSCH transmitted to the SCell based on a control channel regarding UL transmission of the SCell transmitted to the PCell in control channel reception timing of receiving a control channel for UL transmission according to the duplex mode of the SCell.

Referring to FIG. 24, at S2410, the base station can control the cross-carrier scheduling of the terminal. For example, in the case of transmitting control information to the terminal, when the PCell and the SCell operating in different duplex modes are configured, it is possible to control the cross-carrier scheduling of the terminal on the SCell by transmitting control information regarding the SCell to the control channel of the PCell. For example, UL grant information regarding the PUSCH may be transmitted to the SCell on the control channel of the PCell. In this case, since information indicating that the UL grant of the relevant control channel is related to the SCell is included, the terminal can recognize that the information of the received control channel is related to the SCell.

At S2420, the base station can receive the PUSCH transmitted to the SCell based on the control channel regarding UL transmission of the SCell transmitted to the PCell in control channel reception timing regarding UL transmission according to the duplex mode of the PCell. For example, when the terminal cross-carrier scheduled receives control information regarding the PUSCH transmitted to the SCell, control channel reception timing and PUSCH timing may be established based on the duplex mode of the PCell. The base station can receive the PUSCH, transmitted based on the duplex mode timing of the PCell, on the SCell. For example, timing established according to the TDD duplex mode of the PCell may be applied to the PDCCH/EPDCCH of the PUSCH received from the FDD SCell. That is, if the PCell operates in the TDD duplex mode, the base station can receive the PUSCH transmitted from the SCell in the control channel reception timing and the PUSCH transmission timing defined according to the TDD UL-DL configurations, as illustrated in FIG. 9.

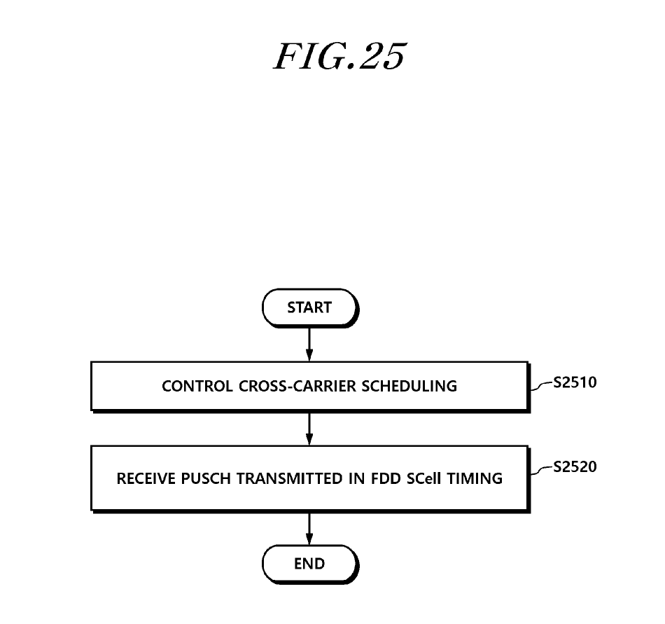

FIG. 25 is a diagram illustrating an exemplary operation of a base station when a terminal is cross-carrier schedule according to still another embodiment of the present disclosure.

In accordance with still another embodiment of the present disclosure, a method may be provided for controlling, in a base station, PUSCH transmission of a terminal configured with a PCell operating in FDD duplex mode and a SCell operating in TDD duplex mode. The method includes: controlling the PCell to perform cross-carrier scheduling on the SCell; and receiving a PUSCH transmitted to the SCell based on a control channel regarding UL transmission of the SCell transmitted to the PCell in control channel reception timing which is timing of receiving a control channel for UL transmission according to the duplex mode of the SCell.

Referring to FIG. 25, at S2510, the base station can control the cross-carrier scheduling of the terminal. For example, in the case of transmitting control information to the terminal configured with the PCell and the SCell operating in different duplex modes, it is possible to control the cross-carrier scheduling of the terminal on the SCell by transmitting control information regarding the SCell to the control channel of the PCell. For example, UL grant information regarding the PUSCH may be transmitted to the SCell on the control channel of the PCell. In this case, since information indicating that the UL grant of the relevant control channel is related to the SCell is included, the terminal can recognize that the information of the received control channel is related to the SCell.

At S2520, the base station can receive the PUSCH transmitted to the SCell based on the control channel regarding UL transmission of the SCell transmitted to the PCell in control channel reception timing regarding UL transmission according to the duplex mode of the SCell. For example, when the terminal cross-carrier scheduled receives control information regarding the PUSCH transmitted to the SCell, control channel reception timing and PUSCH timing may be established based on the duplex mode of the SCell. The base station can receive the PUSCH, transmitted based on the duplex mode timing of the SCell, on the SCell. For example, timing established according to the FDD duplex mode of the SCell may be applied to the PDCCH/EPDCCH of the PUSCH received from the FDD SCell. For example, the PUSCH received by the base station may be transmitted on the n^{th} subframe from the SCell, based on control information included in the PDCCH/EPDCCH transmitted on the (n−4)^{th} subframe in FDD control channel reception timing. That is, the transmission timing of the PDCCH/EPDCCH and the PUSCH may be about 4 ms. Alternatively, the transmission timing may be established as an interval of 4 TTI.

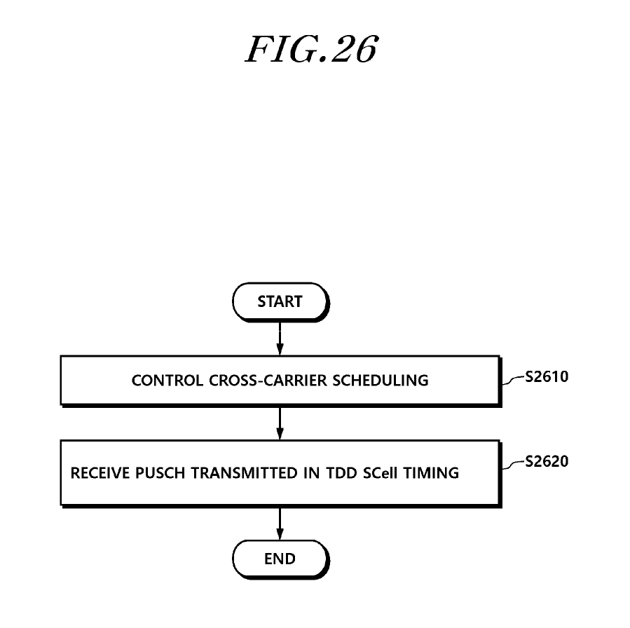

FIG. 26 is a diagram illustrating an exemplary operation of a base station when a terminal is cross-carrier schedule according to another embodiment of the present disclosure.

In accordance with another embodiment of the present disclosure, a method may be provided for controlling, in a base station, PUSCH transmission of a terminal configured with a PCell operating in FDD duplex mode and an SCell operating in TDD duplex mode. The method includes: controlling the PCell to perform cross-carrier scheduling on the SCell; and receiving a PUSCH transmitted to the SCell based on a control channel regarding UL transmission of the SCell transmitted to the PCell in control channel reception timing which is timing of receiving a control channel for UL transmission according to the duplex mode of the SCell.

Referring to FIG. 26, at S2610, the base station can control the cross-carrier scheduling of the terminal. For example, in the case of transmitting control information to the terminal configured with the PCell and the SCell operating in different duplex modes, it is possible to control the cross-carrier scheduling of the terminal on the SCell by transmitting control information regarding the SCell to the control channel of the PCell. For example, UL grant information regarding the PUSCH may be transmitted to the SCell on the control channel of the PCell. In this case, since information indicating that the UL grant of the relevant control channel is related to the SCell is included, the terminal can recognize that the information of the received control channel is related to the SCell.

At S2620, the base station can receive the PUSCH transmitted to the SCell based on the control channel regarding UL transmission of the SCell transmitted to the PCell in control channel reception timing which is timing of receiving a control channel for UL transmission according to the duplex mode of the SCell. For example, when the terminal subjected to cross-carrier scheduling receives control information regarding the PUSCH transmitted to the SCell, control channel reception timing and PUSCH timing may be established based on the duplex mode of the SCell. The base station can receive the PUSCH, transmitted based on the duplex mode timing of the SCell, on the SCell. For example, timing established according to the TDD duplex mode of the SCell may be applied to the PDCCH/EPDCCH of the PUSCH received from the TDD SCell. That is, if the SCell operates in the TDD duplex mode, the base station can receive the PUSCH transmitted from the SCell in the control channel reception timing and the PUSCH transmission timing defined according to the TDD UL-DL configurations, as illustrated in FIG. 9.

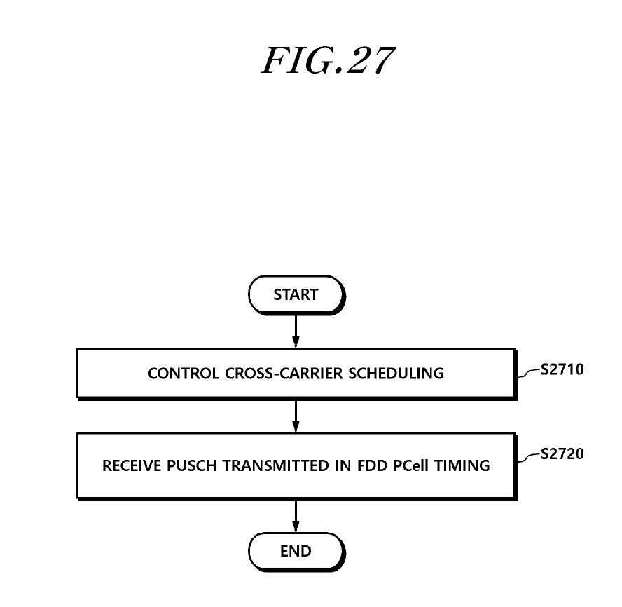

FIG. 27 is a diagram illustrating another exemplary operation of a base station when a terminal is cross-carrier scheduled according to another embodiment of the present disclosure.

In accordance with another embodiment of the present disclosure, a method may be provided for controlling, in a base station, PUSCH transmission of a terminal configured with a PCell operating in FDD duplex mode and an SCell operating in TDD duplex mode. The method includes: controlling the PCell to perform cross-carrier scheduling on the SCell; and receiving a PUSCH transmitted to the SCell based on a control channel for UL transmission of the SCell transmitted to the PCell in control channel reception timing which is timing of receiving a control channel for UL transmission according to the duplex mode of the PCell.

Referring to FIG. 27, at S2710, the base station can control the cross-carrier scheduling of the terminal. For example, in the case of transmitting control information to the terminal configured with the PCell and the SCell operating in different duplex modes, it is possible to control the cross-carrier scheduling of the terminal on the SCell by transmitting control information regarding the SCell to the control channel of the PCell. For example, UL grant information regarding the PUSCH may be transmitted to the SCell on the control channel of the PCell. In this case, since information indicating that the UL grant of the relevant control channel is related to the SCell is included, the terminal can recognize that the information of the received control channel is related to the SCell.

At S2720, the base station can receive the PUSCH transmitted to the SCell based on the control channel for transmitting UL of the SCell to the PCell in control channel reception timing which is timing of receiving a control channel for UL transmission according to the duplex mode of the PCell. For example, when the terminal subjected to cross-carrier scheduling receives control information regarding the PUSCH transmitted to the SCell, control channel reception timing and PUSCH timing may be established based on the duplex mode of the PCell. The base station can receive the PUSCH, transmitted based on the duplex mode timing of the PCell, on the SCell. For example, timing established according to the FDD duplex mode of the PCell may be applied to the PDCCH/EPDCCH of the PUSCH received from the FDD SCell. For example, the PUSCH received by the base station may be transmitted on the n^{th} subframe from the SCell, based on control information included in the PDCCH/EPDCCH transmitted on the (n−4)^{th} subframe in FDD control channel reception timing. That is, the transmission timing of the PDCCH/EPDCCH and the PUSCH may be 4 ms. Alternatively, the transmission timing may be established as an interval of 4 TTI.

According to the present disclosure as set forth above, it is possible to remove the ambiguity between the terminal and the base station regarding the procedures of the terminal, which operates according to the PCell/SCell configurations established between the terminal and the base station, and the configurations of the base station when performing CA using carriers having different duplex modes, i.e. TDD and FDD modes. In addition, it is possible to accurately establish the transmission and reception procedures on the UL/DL control channels between the terminal and the base station, including access procedures, UL/DW data transmissions, and HARQ procedures. Furthermore, it is possible to obtain reliability on the data transmission between the terminal and the base station, thereby increasing UL/DW data transmission rates.

The configurations of a terminal and a base station able to realize the present disclosure as set forth above will be now described with reference to the accompanying drawings.

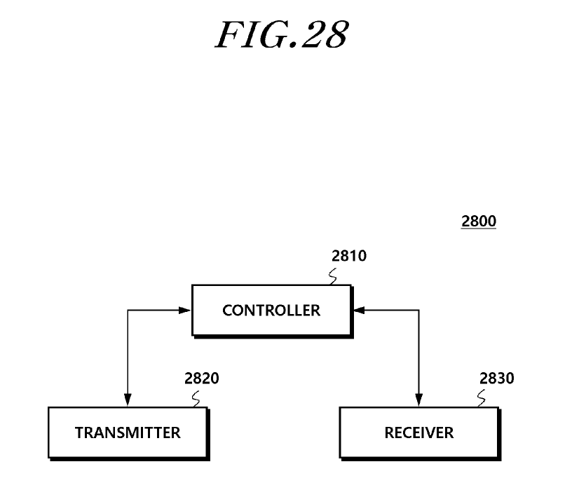

FIG. 28 is a diagram illustrating a configuration of a terminal according to another embodiment of the present disclosure.

Referring to FIG. 28, the terminal 2800 according to another embodiment of the present disclosure includes a controller 2810, a transmitter 2820, and a receiver 2830.

According to an embodiment of the present disclosure, the terminal processes a control channel, in which a PCell and an SCell operating in different duplex modes are configured. In the terminal, the controller 2810 controls the PCell and the SCell to be self-carrier scheduled. The transmitter 2820 transmits a PUSCH to each of the PCell and the SCell based on the control channel received in control channel reception timing which is timing of receiving a control channel for the UL transmission of the duplex mode of each of the PCell and the SCell.

In addition, according to another embodiment of the present disclosure, the terminal may process the control channel when the PCell operating in TDD duplex mode and the SCell operating in FDD duplex mode are configured. Such a terminal may include a controller 2810 and a transmitter 2820. The controller 2810 controls the PCell to perform cross-carrier scheduling on the SCell. The transmitter 2820 transmits a PUSCH to the SCell based on a control channel received from the PCell in control channel reception timing regarding UL transmission according to the duplex mode of the PCell.

Furthermore, according to still another embodiment of the present disclosure, the terminal may process the control channel when the PCell operating in TDD duplex mode and the SCell operating in FDD duplex mode are configured. Such a terminal may include the controller 2810 and the transmitter 2820. The controller 2810 controls the PCell to perform cross-carrier scheduling on the SCell, and the transmitter 2820 transmits a PUSCH to the SCell based on a control channel received from the PCell in control channel reception timing regarding UL transmission according to the duplex mode of the SCell.

In addition, according to yet another embodiment of the present disclosure, the terminal may process the control channel when the PCell operating in FDD duplex mode and the SCell operating in TDD duplex mode are configured. The terminal includes the controller 2810 and the transmitter 2820. The controller 2810 controls the PCell to perform cross-carrier scheduling on the SCell, and the transmitter 2820 transmits a PUSCH to the SCell based on a control channel received from the PCell in control channel reception timing regarding UL transmission according to the duplex mode of the SCell.

Furthermore, according to yet another embodiment of the present disclosure, the terminal may process the control channel when the PCell operating in FDD duplex mode and the SCell operating in TDD duplex mode are configured. The terminal includes the controller 2810 and the transmitter 2820. The controller 2810 controls the PCell to perform cross-carrier scheduling on the SCell, and the transmitter 2820 transmits a PUSCH to the SCell based on a control channel received from the PCell in control channel reception timing regarding UL transmission according to the duplex mode of the PCell.

In addition, the controller 2810 controls the overall operation of the terminal to process the control channel reception timing and the PUSCH transmission timing according to duplex modes when operating in different duplex modes for realizing the embodiments of the present disclosure.

Furthermore, the receiver 2830 can receive the control channel transmitted in predetermined timing according to the above-described embodiments. In addition, the transmitter 2820 and the receiver 2830 are used to transmit and receive signals, messages, and data required to realize the above-described features of the present disclosure to and from the base station.

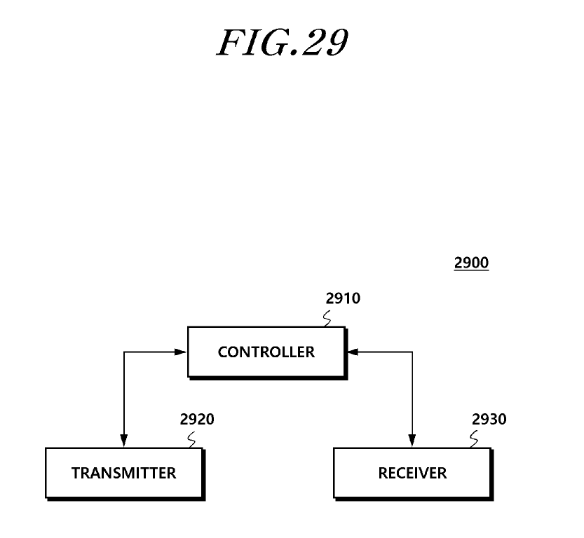

FIG. 29 is a diagram illustrating the configuration of a base station according to an embodiment of the present disclosure.

Referring to FIG. 29, the base station 2900 according to an embodiment of the present disclosure includes a receiver 2930, a controller 2910, and a transmitter 2920.

According to an embodiment of the present disclosure, the base station controls PUSCH transmission of a terminal when a PCell and an SCell operating in different duplex modes are configured. Such a base station includes the controller 2910 and the receiver 2930. The controller 2910 controls the PCell and the SCell to be self-carrier scheduled. The receiver 2930 receives a PUSCH transmitted to each of the PCell and the SCell based on a control channel transmitted from each of the PCell and the SCell in control channel reception timing which is timing of receiving a control channel for UL transmission in the duplex mode of each of the PCell and the SCell.

In addition, according to another embodiment of the present disclosure, the base station controls PUSCH transmission of a terminal when a PCell operating in TDD duplex mode and an SCell operating in FDD duplex mode are configured. The controller 2910 controls the PCell to perform cross-carrier scheduling on the SCell. The receiver 2930 receives a PUSCH transmitted to the SCell based on a control channel regarding UL transmission of the SCell transmitted to the PCell in control channel reception timing which is timing of receiving a control channel for UL transmission according to the duplex mode of the PCell.

Furthermore, according to further another embodiment of the present disclosure, the base station controls PUSCH transmission of a terminal when a PCell operating in TDD duplex mode and an SCell operating in FDD duplex mode are configured. The controller 2910 controls the PCell to perform cross-carrier scheduling on the SCell. The receiver 2930 receives a PUSCH transmitted to the SCell based on a control channel regarding UL transmission of the SCell transmitted to the PCell in control channel reception timing which is timing of receiving a control channel for UL transmission according to the duplex mode of the SCell.

In addition, according to still another embodiment of the present disclosure, the base station controls PUSCH transmission of a terminal when a PCell operating in FDD duplex mode and an SCell operating in TDD duplex mode are configured. The controller 2910 controls the PCell to perform cross-carrier scheduling on the SCell. The receiver 2930 receives a PUSCH transmitted to the SCell based on a control channel which is timing of receiving a control channel for UL transmission of the SCell transmitted to the PCell in control channel reception timing regarding UL transmission according to the duplex mode of the SCell.

Furthermore, according to further still another embodiment of the present disclosure, the base station controls PUSCH transmission of a terminal when a PCell operating in FDD duplex mode and an SCell operating in TDD duplex mode are configured. The controller 2910 controls the PCell to perform cross-carrier scheduling on the SCell. The receiver 2930 receives a PUSCH transmitted to the SCell based on a control channel regarding UL transmission of the SCell transmitted to the PCell in control channel reception timing which is timing of receiving a control channel for UL transmission according to the duplex mode of the PCell.

In addition, the controller 2910 controls the overall operation of the base station to receive and process the PUSCH transmitted based on the control channel reception timing and the PUSCH transmission timing that may be established differently depending on duplex modes by the terminal operating in different duplex modes as required to realize the embodiments of the present disclosure.

Furthermore, the receiver 2930 receives UL control information, data, and messages from the terminal on a relevant channel.

In addition, the transmitter 2920 can transmit a PDCCH or EPDCCH including a UL grant to the terminal on the control channel. Furthermore, DL control information, data, and messages are transmitted on the relevant channel.

The foregoing descriptions and the accompanying drawings have been presented in order to explain the certain principles of the present invention. A person skilled in the art to which the invention relates can make many modifications and variations by combining, dividing, substituting for, or changing the elements without departing from the principle of the invention. The foregoing embodiments disclosed herein shall be interpreted as illustrative only but not as limitative of the principle and scope of the invention. It should be understood that the scope of the invention shall be defined by the appended Claims and all of their equivalents fall within the scope of the invention.

### CROSS-REFERENCE TO RELATED APPLICATION

This application claims priority from and the benefit under 35 U.S.C. §119(a) of Korean Patent Application Number 10-2013-0115725 filed on Sep. 27, 2013 and Korean Patent Application Number 10-2014-0061203 filed on May 21, 2014, which are hereby incorporated by reference for all purposes as if fully set forth herein. When priority is claimed for the same reasons under the patent laws of any countries other than the United States, all contents of these documents are hereby incorporated by reference.

1-20. (canceled)

21. A method of processing a control channel by a terminal configured with a primary cell and a secondary cell operating in different duplex modes, the method comprising:
performing carrier scheduling on at least one of the primary cell and the secondary cell; and
transmitting a PUSCH to at least one of the primary cell and the secondary cell based on a control channel received in control channel reception timing which is timing of receiving a control channel for uplink transmission in the duplex mode of the primary cell and/or the secondary cell.

22. The method according to claim 21, wherein,
the performing carrier scheduling comprises performing self-carrier scheduling on the primary cell and the secondary cell; and
the transmitting a PUSCH comprises transmitting a PUSCH to each of the primary cell and the secondary cell based on a control channel received in control channel reception timing which is timing of receiving a control channel for uplink transmission in the duplex mode of each of the primary cell and the secondary cell.

23. The method according to claim 21, wherein the duplex mode of the primary cell is established as time division duplex (TDD), and the duplex mode of the secondary cell is established as frequency division duplex (FDD).

24. The method according to claim 21, wherein the duplex mode of the primary cell is established as frequency division duplex (FDD), and the duplex mode of the secondary cell is established as time division duplex (TDD).

25. The method according to claim 23, wherein,
performing carrier scheduling comprises performing cross-carrier scheduling on the secondary cell from the primary cell; and
transmitting a PUSCH comprises transmitting a PUSCH to the secondary cell based on a control channel received from the primary cell in control channel reception timing which is timing of receiving a control channel for uplink transmission according to the duplex mode of the secondary cell.

26. The method according to claim 24, wherein,
performing carrier scheduling comprises performing cross-carrier scheduling on the secondary cell from the primary cell; and
transmitting a PUSCH comprises transmitting a PUSCH to the secondary cell based on a control channel received from the primary cell in control channel reception timing which is timing of receiving a control channel for uplink transmission according to the duplex mode of the secondary cell.

27. A method of controlling, by a base station, PUSCH transmission of a terminal configured with a primary cell and a secondary cell operating in different duplex modes, the method comprising:
controlling at least one of the primary cell and the secondary cell to be carrier scheduled; and
receiving a PUSCH transmitted to at least one of the primary cell and the secondary cell based on a control channel transmitted from at least one of the primary cell and the secondary cell in control channel reception timing which is timing of receiving a control channel for uplink transmission in the duplex mode of at least one of the primary cell and the secondary cell.

28. The method according to claim 27, wherein,
controlling the primary cell and/or the secondary cell comprises controlling each of the primary cell and the secondary cell to be self-carrier scheduled; and
receiving a PUSCH comprises receiving a PUSCH transmitted to each of the primary cell and the secondary cell based on a control channel transmitted from each of the primary cell and the secondary cell in control channel reception timing which is timing of receiving a control channel for uplink transmission in the duplex mode of each of the primary cell and the secondary cell.

29. The method according to claim 27, wherein the duplex mode of the primary cell is established as time division duplex (TDD), and the duplex mode of the secondary cell is established as frequency division duplex (FDD).

30. The method according to claim 27, wherein the duplex mode of the primary cell is established as frequency division duplex (FDD), and the duplex mode of the secondary cell is established as time division duplex (TDD).

31. The method according to claim 29, wherein,
controlling the primary cell and/or the secondary cell comprises controlling the primary cell to perform cross-carrier scheduling on the secondary cell; and
receiving a PUSCH comprises receiving a PUSCH transmitted to the secondary cell based on a control channel regarding uplink transmission of the secondary cell transmitted to the primary cell in control channel reception timing is timing of receiving a control channel for uplink transmission according to the duplex mode of the secondary cell.

32. The method according to claim 30, wherein,
controlling the primary cell and/or the secondary cell comprises controlling the primary cell to perform cross-carrier scheduling on the secondary cell; and
receiving a PUSCH comprises receiving a PUSCH transmitted to the secondary cell based on a control channel regarding uplink transmission of the secondary cell transmitted to the primary cell in control channel reception timing which is timing of receiving a control channel for uplink transmission according to the duplex mode of the secondary cell.

33. A terminal for processing a control channel when a primary cell and a secondary cell operating in different duplex modes are configured, the terminal comprising:
a controller controlling at least one of the primary cell and the secondary cell to be carrier scheduled; and
a transmitter transmitting a PUSCH to at least one of the primary cell and the secondary cell based on a control channel received in control channel reception timing which is timing of receiving a control channel for uplink transmission in the duplex mode of the primary cell and/or the secondary cell.

34. The terminal according to claim 33,
wherein the controller controls the primary cell and the secondary cell to be self-carrier scheduled; and
wherein the transmitter transmits a PUSCH to each of the primary cell and the secondary cell based on a control channel received in control channel reception timing which is timing of receiving a control channel for uplink transmission in the duplex mode of each of the primary cell and the secondary cell.

35. The terminal according to claim 33, wherein the duplex mode of the primary cell is established as time division duplex (TDD), and the duplex mode of the secondary cell is established as frequency division duplex (FDD).

36. The terminal according to claim 33, wherein the duplex mode of the primary cell is established as frequency division duplex (FDD), and the duplex mode of the secondary cell is established as time division duplex (TDD).

37. The terminal according to claim 35,
wherein the controller controls the secondary cell to be cross-carrier scheduled from the primary cell; and
wherein the transmitter transmits a PUSCH to the secondary cell based on a control channel received from the primary cell in control channel reception timing which is timing for receiving a control channel for uplink transmission according to the duplex mode of the secondary cell.

38. The terminal according to claim 36, wherein:
the controller is configured to controls the secondary cell to be cross-carrier scheduled from the primary cell; and
the transmitter is configured to transmit a PUSCH to the secondary cell based on a control channel received from the primary cell in control channel reception timing which is timing of receiving a control channel for uplink transmission according to the duplex mode of the secondary cell.
